(19) United States
(12) Patent Application Publication
(10) Pub. No.: US 2020/0329698 A1
(43) Pub. Date: Oct. 22, 2020

(54) COMPOSITIONS FOR ORGAN GRAFT PRESERVATION AND METHODS OF USE

(71) Applicant: Nobilis Therapeutics, Inc., Portland, OR (US)

(72) Inventors: Daqing MA, London (GB); Hailin ZHAO, Kent (GB); Andrew J.T. GEORGE, Twickenham (GB); Qian CHEN, Chongqing (CN); Jiateng GU, Chongqing (CN); Jiaolin NING, Chongqing (CN); Kaizhi LU, Chongqing (CN)

(73) Assignee: Nobilis Therapeutics, Inc., Portland, OR (US)

(21) Appl. No.: 16/389,869

(22) Filed: Apr. 19, 2019

(51) Int. Cl. A01N 1/02

(52) U.S. Cl. CPC A01N 1/0226

(57) ABSTRACT

The invention provides compositions, treatment means and protocols for induction of protective effects of organ grafts by administration of Dexmedetomidine, in combination with/without xenon or argon, in the conventional organ graft preservation solution storage solution. In one particular embodiment, the invention provides the activation of molecular pathways associated with reduction of oxidative stress and inhibition of regulated necrosis.

### BACKGROUND

Organ transplantation is the optimal treatment for patients with end-stage organ failure and provides the best clinical outcomes, good quality of life and cost savings when compared with other modalities of organ replacement therapy. Despite the demonstrated advantages of transplantation, the full potential of these benefits cannot be obtained due to the severe shortage of donated organs, such as kidneys[5]. Efforts underway to expand the potential donor pool have included use of ‘Extended Criteria’ (EC) or ‘marginal’ donors, as well as increasing use of organs from non-heart beating donors (NHBD)—now donation after cardiac arrest and brain death.

In the case of the optimal donor, i.e. the living donor, organ injury is minimal. Marginal donor organs, such as kidneys from non-heart beating donors (DCD donor) and brain-dead donors (DBD donor), however, are injured due to a certain period of warm ischemia. When circulation has stopped and tissue becomes hypoxic, progressive damage is inflicted on the organ [6, 7]. In addition, donor brain death has been considered a significant risk factor for both early and late organ allograft dysfunction. This central injury not only evokes an upsurge of catecholamines, with resultant peripheral tissue vasoconstriction and ischemia, but also promotes release of hormones and inflammatory mediators that may also affect the organs directly [8, 9]. The early injury and the associated reperfusion after transplantation evoke nonspecific inflammatory changes in the affected organs [7]. In contrast, donation with cardiac arrest (DCD donor) kidneys may experience prolonged periods of warm ischemia, and this manifests as higher rates of post-operative graft dysfunction[3], specifically delayed graft function (DGF)>80%, and primary non function (PNF)>9%, in transplant recipients of DCD category kidneys; compared to 23% DGF in cadaveric heart beating donors[10]. Similarly, kidneys from marginal and EC donors are presumed to be of compromised quality and more susceptible to ischemic injury, and in clinical transplantation are associated with increased rates of both DGF and PNF when compared to non-marginal donor kidneys [11]. It is currently a major challenge currently how marginal kidney grafts can be utilised clinically for our patients' best benefit.

DCD and DBD organs often experience prolonged periods of warm ischemia, and this manifests as higher rates of post-operative graft dysfunction [15], specifically delayed graft function (DGF), and primary non function (PNF) in transplant recipients[10]. Similarly, kidneys from marginal and EC donors are likely to be of compromised quality and more susceptible to ischemic injury which are associated with increased rates of both DGF and PNF when compared to non-marginal donor kidneys [11]. DGF itself necessitates continued dialysis, and is associated with an increased risk of acute rejection and poorer long term outcome [16]. As the use of marginal donor kidneys increases, the impact of IR injury on DGF and the long-term outcome is likely to increase in a parallel manner.

Effective preserving strategies to ameliorate donor kidney (and other organ) graft ischemia injury will serve to both improve graft function after engraftment while also expanding the pool of marginal donor organs. More than 9,000 people in the UK need an organ transplant to save or improve the quality of their lives; most are awaiting kidneys. In 2007, 6,200 patients were on the waiting list for kidney transplantation (http://www.uktransplant.org.uk/). Organ including lung transplantation is the only definitive treatment for most patients with end-stage pulmonary disease, such as those with chronic obstructive pulmonary disease (COPD), idiopathic pulmonary fibrosis and cystic fibrosis. Despite improvements in surgical management, peri-operative care and immunosuppression, the outcome from lung transplantation remains the worst amongst any solid organ transplant and is associated with a median survival rate of only 5.8% [1, 2]. The long-term success of lung transplantation is significantly limited by primary graft dysfunction secondary to ischemia-reperfusion injury. To further complicate matters, the number of new candidates added to lung transplant waiting lists has increased every year by 67.7%, resulting in a significant discrepancy between transplant supply and demand, which continues to increase [3].

Donor organs are therefore highly precious resources, and any intervention that reduces graft failure would be of enormous benefit. As described herein, the proposed therapeutants protect against ischemia reperfusion injury (IRI) and “rescue” marginal grafts, thereby improving the survival and function of the transplanted marginal grafts.

Ischemia-reperfusion injury (IRI), defined as “the cellular damage after reperfusion of previously viable ischemic tissues” [12], has been an inevitable event during transplantation. IRI is a devastating process leading to delayed graft function (DGF) and reduced long-term survival in renal transplantation. Highly complex mechanisms involving the innate immune system play an important role in the pathophysiology of renal IRI. The direct ischemic insult leads to acute tubular necrosis, accounting for perioperative acute renal failure (ARF) [13]. Renal IRI provokes a robust acute inflammatory response. During the reperfusion phase, the restoration of blood flow may initiate recovery, yet may also paradoxically induce further injury by damage-associated molecular pattern molecules (DAMPs) liberated from necrotic tissue during the ischemic phase. These ligands bind to pattern recognition receptors, such as Toll-like receptors (TLRs) to initiate a signaling cascade that involves the activation of nuclear factor-κB (NF-κB) and leads to the transcription and translation of inflammatory mediators such as TNF-alpha, IL-1beta, IL-6, as well as pro-apoptotic proteins from kidney tubular cells [14]. Hence IRI has been considered a major contributor for shortening the long-term survival of grafts.

Optimization of organ viability begins with the choice of preservation method. Currently, there are two dominant methods for preservation: (1) static cold storage (CS) [13] and (2) hypothermic machine perfusion (RM3 Perfusion Device, e.g., LIFEPORT® [14]). CS involves flushing the retrieved organ with a preservative solution, commonly Marshall's hypertonic citrate (SOLTRAN™, BAXTER® HEALTHCARE) or Belzer UW solution (VIASPAN®, BRISTOL MYERS SQUIBB®), and then packing on ice for transport. CS preservation relies on the suppression of cellular metabolism via hypothermia as the organ is flushed free of blood and replaced by the infused cold preservative solution. This method of preservation however was developed in an era of younger donors with higher quality organs [16] and with the recent trend of diminishing availability of heart beating donors, and increasing reliance on marginal organs, the limitations of using CS for effective preservation is seen to have been reached [17]. Research into the use of machine perfusion for the optimization of kidney grafts has been ongoing for several years and gradually gained popularity worldwide. It has been taken as a standard organ preserving procedure, especially for marginal donor organ in some transplantation centers for better outcome [18].

While some described studies herein are focused on renal transplantation, the clinical utility of the methods herein extended to all organ transplantation in which ischemic/reperfusion injury can impair graft function. The significance of novel therapies to manage ischemia-reperfusion injury is particularly evident when viewing primary graft failure within the context of an already depleted donor pool with a simultaneously increasing demand for grafts. Thus, there is a strong need for therapeutic advances to prevent ischemia reperfusion injury and associated primary graft dysfunction in order to improve patient outcomes post-transplantation.

Xenon

The noble gas xenon has been using clinically for more than 50 years as an anaesthetic and a tracer in radiology. In particular, it has been used as an anaesthetic since the 1950s, with a remarkable safety profile [19]. In a series of preclinical studies, we have demonstrated that xenon confers protection against vital organ (e.g., brain, kidney) ischemia-reperfusion injury. Xenon can protect against kidney warm ischemic injury[20]. Using a rat transplantation model, it has been demonstrated that application of xenon to living donor before graft retrieval or to recipient after engraftment protected against early graft injury and prolonged graft survival in isografts, weak immune-allografts and strong immuno-allografts [21], [22] [23]). Most importantly, the PI's group has recently reported that in an ex vivo graft (from living donor) preserving experiment, the kidney was stored with ice-cold Soltran preserving solution saturated with 70% Xe and 5% CO₂ balanced with O₂ for 24 hrs. Kidneys maintained in SOLTRAN™ solution containing gases of 70% N₂, and 5% CO₂ balanced with O₂ served as controls. Xenon exposure enhanced expression of Bcl-2 and HSP-70. The morphological structure of the ex-vivo rat kidney was well preserved in the xenon-containing SOLTRAN™ solution. Twenty-four hrs after engraftment, tubular cell death was significantly decreased in the xenon treated grafts. Renal inflammation and delayed graft function were reduced and on day 8 after surgery, macrophage infiltration and fibrosis were significantly reduced[24]. However, such effects of xenon on ex vivo marginal grafts have not previously been evaluated yet.

Argon

Argon, an abundant noble gas, has also shown organ-protective properties in vitro [25] and in vivo[26]. We have recently demonstrated that 70% argon is neuro-protective in a rat model of hypoxia-ischemia brain injury [27]. In addition, the preserving solution saturated with argon has been demonstrated to be superior in preserving renal grafts from live donor against hypothermic-ischemic injury[28] but the mechanism responsible for its effect and also its effects on ex vivo marginal grafts have not been investigated.

Dexmedetomidine (DEX)

The α₂ adrenoceptor agonist exerts sedative, analgesic effects in the patients undergoing surgery. In addition, it is associated with potent hemodynamic stabilizing and anti-inflammatory and anti-apoptotic effects [29]. Novel organ protective properties of DEX have been explored in the brain injury [30]. Thereafter, several studies have investigated whether DEX has reno-protective effects. The PI's teams work has shown that mice treated with dexmedetomidine showed comparatively significant reduced level of p-JAK2 and its downstream effectors p-STAT1 and STATS in the warm ischemia-reperfusion injury. This suggested dexmedetomidine inhibited the JAK/STAT signaling pathway, which is associated with apoptosis [31]. Pre- or post-treatment with DEX provided cytoprotection via Akt cellular signal pathways, improved tubular architecture and function following renal ischemia. Dexmintomindine treatment provided long-term functional renoprotection, and increased survival [32].

### SUMMARY

The teachings herein are directed to methods of inducing factors that promote cell survival after ischemia-reperfusion, said methods comprising contacting Dexmedetomidine in combination with xenon and/or argon with a human organ at sufficient concentration and duration to protect against ischemic damage.

Suitable organs for preservation non-exclusively include any organ type suitable for transplantation, non-exclusively including heart, lung, kidney, liver, intestine, pancreas, vasculature, cornea and skin. While the primary teachings herein are directed to organs, additional embodiments can utilize the same or similar methods of preservation and transplantation with composite tissue grafts. Composite tissue grafts are constructs made up of tissue, that can non-exclusively include: skin, muscle, tendon, nerves, bone and blood vessels from a donor that can be transplanted to a recipient.

Treating the organ with Dexmedetomidine can be done during ex vivo preservation stage and/or in vivo after the recipient receives the donor organ or to the donor before removal of the organ.

Suitable organs for preservation non-exclusively include organs from live donors, DCD (donation after cardiac death) donors, DBD (donation after brain death) donors, EC (expanded criteria) donors.

Treating with Dexmedetomidine can include treating the organ in ex vivo preservation stage, with any suitable or currently available preserving solution on the commercial market, including UW solution, soltran solution and Collins solution. In further embodiments, Dexmedetomidine can be applied to both static cold storage and machine perfusion method.

The success of organ transplantation is significantly dependent on the quality of the donor organ which, in turn, is determined by a range of factors including donor management prior to organ procurement and the quality of organ preservation. With increasing use of marginal donor organs, novel strategy of improving the quality of organ preservation remains the focus of renal transplantation research, which benefit for the long-term graft performance and survival.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a model perfusion system allowing Dexmedetomidine and noble gases to treat rat renal grafts.

FIG. 1B shows hematoxylin and eosin stains of rat renal grafts from marginal donors (DBD and DCD) after 24 hrs of cold ischemia with vehicle control and dexmedetomidine treatment.

FIG. 1C shows graphs of kidney injury scoring based on the hematoxylin and eosin stains of FIG. 1B.

FIG. 2A shows TUNEL stains of rat renal grafts from marginal donors (DBD and DCD) after 24 hrs of cold ischemia with vehicle control and dexmedetomidine treatment.

FIG. 2B shows graphs of TUNEL+ cells based on the stains of FIG. 2A.

FIG. 2C shows MLKL stains of rat renal grafts from marginal donors (DBD and DCD) after 24 hrs of cold ischemia with vehicle control and dexmedetomidine treatment.

FIG. 2D shows graphs of MLKL fluorescence intensity cells based on the stains of FIG. 2C.

FIG. 3A shows HO-1 stains of rat renal grafts from marginal donors (DBD and DCD) after 24 hrs of cold ischemia with vehicle control and dexmedetomidine treatment.

FIG. 3B shows graphs of HO-1 fluorescence intensity cells based on the stains of FIG. 3A.

FIG. 3C shows Nrf-2 stains of rat renal grafts from marginal donors (DBD and DCD) after 24 hrs of cold ischemia with vehicle control and dexmedetomidine treatment.

FIG. 3D shows graphs of Nrf-2 fluorescence intensity cells based on the stains of FIG. 3C.

FIG. 4A shows a graph of creatine expression in rat renal grafts from marginal donors (DBD and DCD) after 24 hrs of cold ischemia with vehicle control and dexmedetomidine treatment.

FIG. 4B shows a graph of urea expression in rat renal grafts from marginal donors (DBD and DCD) after 24 hrs of cold ischemia with vehicle control and dexmedetomidine treatment.

FIG. 4C shows a graph of IL-1β expression in rat renal grafts from marginal donors (DBD and DCD) after 24 hrs of cold ischemia with vehicle control and dexmedetomidine treatment.

FIG. 4D shows a graph of TNF-α expression in rat renal grafts from marginal donors (DBD and DCD) after 24 hrs of cold ischemia with vehicle control and dexmedetomidine treatment.

FIG. 4E shows TUNEL stains of rat renal grafts from DCD donors after 24 hrs of cold ischemia with vehicle control and dexmedetomidine treatment.

FIG. 4F shows CD68+ stains of rat renal grafts from DCD donors after 24 hrs of cold ischemia with vehicle control and dexmedetomidine treatment.

FIG. 4G shows MTS stains of rat renal grafts from DCD donors after 24 hrs of cold ischemia with vehicle control and dexmedetomidine treatment.

FIG. 4H shows a graph of TUNEL+ cells expression in rat renal grafts from marginal donors (DBD and DCD) after 24 hrs of cold ischemia with vehicle control and dexmedetomidine treatment based on the stains of FIG. 4E.

FIG. 4I shows a graph of CD68+ macrophage expression in rat renal grafts from marginal donors (DBD and DCD) after 24 hrs of cold ischemia with vehicle control and dexmedetomidine treatment based on the stains of FIG. 4F.

FIG. 4J shows a graph of MTS stained area in rat renal grafts from marginal donors (DBD and DCD) after 24 hrs of cold ischemia with vehicle control and dexmedetomidine treatment based on the stains of FIG. 4G.

FIG. 5A shows hematoxylin and eosin stains of rat lung grafts from DCD donors after 16 hrs of cold ischemia without treatment.

FIG. 5B shows TUNEL stains of rat lung grafts from DCD donors after 16 hrs of cold ischemia without treatment.

FIG. 5C shows a graph of TNF-α expression in rat lung grafts from DCD donors after 16 hrs of cold ischemia without treatment.

FIG. 5D shows a graph of IL-1β expression in rat lung grafts from DCD donors after 16 hrs of cold ischemia without treatment.

FIG. 5E shows a graph of HMGB-1 expression in rat lung grafts from DCD donors after 16 hrs of cold ischemia without treatment.

FIG. 5F shows a graph of lung injury scoring in rat lung grafts from DCD donors after 16 hrs of cold ischemia without treatment.

FIG. 5G shows a graph of TUNEL+ expression in rat lung grafts from DCD donors after 16 hrs of cold ischemia without treatment.

FIG. 6A shows Rip1/HMGB-1 stains of rat lung grafts from DCD donors after 16 hrs of cold ischemia without treatment.

FIG. 6B shows Rip3/HMGB-1 stains of rat lung grafts from DCD donors after 16 hrs of cold ischemia without treatment.

FIG. 6C shows Rip3/TLR-4 stains of rat lung grafts from DCD donors after 16 hrs of cold ischemia without treatment.

FIG. 6D shows a graph of Rip1 fluorescence intensity based on the stains of FIG. 6A.

FIG. 6E shows a graph of Rip3 fluorescence intensity based on the stains of FIG. 6B.

FIG. 6F shows a graph of TLR-4 fluorescence intensity based on the stains of FIG. 6C.

FIG. 7A shows hematoxylin and eosin stains of rat lung grafts from DCD donors after 16 hrs of cold ischemia with vehicle control and dexmedetomidine treatment.

FIG. 7B shows a graph of lung injury scoring in rat lung grafts from DCD donors after 16 hrs of cold ischemia with vehicle control and dexmedetomidine treatment.

FIG. 7C shows TUNEL stains and corresponding TUNEL+ expression graph of rat lung grafts from DCD donors after 16 hrs of cold ischemia with vehicle control and dexmedetomidine treatment.

FIG. 7D shows HMGB-1/Rip1 stains of rat lung grafts from DCD donors after 16 hrs of cold ischemia with vehicle control and dexmedetomidine treatment.

FIG. 7E shows HMGB-1/Rip3 stains of rat lung grafts from DCD donors after 16 hrs of cold ischemia with vehicle control and dexmedetomidine treatment.

FIG. 7F shows TLR-4/Rip3 stains of rat lung grafts from DCD donors after 16 hrs of cold ischemia with vehicle control and dexmedetomidine treatment.

FIG. 7G shows a graph of Rip1 fluorescence intensity in rat lung grafts from DCD donors after 16 hrs of cold ischemia with vehicle control and dexmedetomidine treatment.

FIG. 7H shows a graph of Rip3 fluorescence intensity in rat lung grafts from DCD donors after 16 hrs of cold ischemia with vehicle control and dexmedetomidine treatment.

FIG. 7I shows a graph of TLR-4 fluorescence intensity in rat lung grafts from DCD donors after 16 hrs of cold ischemia with vehicle control and dexmedetomidine treatment.

FIG. 7J shows a graph of HMGB-1 expression in rat lung grafts from DCD donors after 16 hrs of cold ischemia with vehicle control and dexmedetomidine treatment.

FIG. 7K shows a graph of TNF-α expression in rat lung grafts from DCD donors after 16 hrs of cold ischemia with vehicle control and dexmedetomidine treatment.

FIG. 7L shows a graph of IL-1β expression in rat lung grafts from DCD donors after 16 hrs of cold ischemia with vehicle control and dexmedetomidine treatment.

FIG. 8A shows Nrf-2/NQO-1 stains of rat lung grafts from DCD donors after 16 hrs of cold ischemia with vehicle control and dexmedetomidine treatment.

FIG. 8B shows Nrf-2/SOD-1 stains of rat lung grafts from DCD donors after 16 hrs of cold ischemia with vehicle control and dexmedetomidine treatment.

FIG. 8C shows a graph of Nrf-2 fluorescence intensity in rat lung grafts from DCD donors after 16 hrs of cold ischemia with vehicle control and dexmedetomidine treatment.

FIG. 8D shows a graph of NQO-1 fluorescence intensity in rat lung grafts from DCD donors after 16 hrs of cold ischemia with vehicle control and dexmedetomidine treatment.

FIG. 8E shows a graph of SOD-1 fluorescence intensity in rat lung grafts from DCD donors after 16 hrs of cold ischemia with vehicle control and dexmedetomidine treatment.

FIG. 8F shows 3-nitrotyrosine/4-hydroxynonenal stains of rat lung grafts from DCD donors after 16 hrs of cold ischemia with vehicle control and dexmedetomidine treatment.

FIG. 8G shows a graph of 3-nitrotyrosine fluorescence intensity in rat lung grafts from DCD donors after 16 hrs of cold ischemia with vehicle control and dexmedetomidine treatment.

FIG. 8H shows a graph of 4-hydroxynonenal fluorescence intensity in rat lung grafts from DCD donors after 16 hrs of cold ischemia with vehicle control and dexmedetomidine treatment.

FIG. 8I shows a graph of GSH expression in rat lung grafts from DCD donors after 16 hrs of cold ischemia with vehicle control and dexmedetomidine treatment.

FIG. 8J shows a graph of GSSG expression in rat lung grafts from DCD donors after 16 hrs of cold ischemia with vehicle control and dexmedetomidine treatment.

FIG. 8K shows a graph of GSH/GSSG expression in rat lung grafts from DCD donors after 16 hrs of cold ischemia with vehicle control and dexmedetomidine treatment.

FIG. 9A shows TLR-4/Rip3 stains of rat lung grafts from DCD donors after 16 hrs of cold ischemia with dexmedetomidine and nrf-2 SiRNA treatment.

FIG. 9B shows TLR-4/Rip3 stains of rat lung grafts from DCD donors after 16 hrs of cold ischemia with dexmedetomidine and atipamezole treatment.

FIG. 9C shows a graph of Rip3 fluorescence intensity in rat lung grafts from DCD donors after 16 hrs of cold ischemia with dexmedetomidine, nrf-2 SiRNA, and atipamezole treatment.

FIG. 9D shows a graph of TLR-4 fluorescence intensity in rat lung grafts from DCD donors after 16 hrs of cold ischemia with dexmedetomidine, nrf-2 SiRNA, and atipamezole treatment.

FIG. 9E shows 3-nitrotyrosine/4-hydroxynonenal stains of rat lung grafts from DCD donors after 16 hrs of cold ischemia with dexmedetomidine and nrf-2 SiRNA treatment.

FIG. 9F shows 3-nitrotyrosine/4-hydroxynonenal stains of rat lung grafts from DCD donors after 16 hrs of cold ischemia with dexmedetomidine and atipamezole treatment.

FIG. 9G shows a graph of 3-nitrotyrosine fluorescence intensity in rat lung grafts from DCD donors after 16 hrs of cold ischemia with dexmedetomidine, nrf-2 SiRNA, and atipamezole treatment.

FIG. 9H shows a graph of 4-hydroxynonenal fluorescence intensity in rat lung grafts from DCD donors after 16 hrs of cold ischemia with dexmedetomidine, nrf-2 SiRNA, and atipamezole treatment.

FIG. 9I shows hematoxylin and eosin stains of rat lung grafts from DCD donors after 16 hrs of cold ischemia with dexmedetomidine, nrf-2 SiRNA, and atipamezole treatment.

FIG. 9J shows a graph of HMGB-1 expression in rat lung grafts from DCD donors after 16 hrs of cold ischemia with dexmedetomidine, nrf-2 SiRNA, and atipamezole treatment.

FIG. 9K shows a graph of lung injury scoring in rat lung grafts from DCD donors after 16 hrs of cold ischemia with dexmedetomidine, nrf-2 SiRNA, and atipamezole treatment.

FIG. 10A shows hematoxylin and eosin stains of rat renal grafts from DCD donors after treated with N₂, Xenon, Argon alone and in combination with dexmedetomidine.

FIG. 10B shows a graph of injury scoring in rat renal grafts from DCD donors after treated with N₂, Xenon, Argon alone and in combination with dexmedetomidine.

FIG. 10C shows TUNEL+ stains of rat renal grafts from DCD donors after treated with N₂, Xenon, Argon alone and in combination with dexmedetomidine.

FIG. 10D shows a graph of TUNEL+ expression in rat renal grafts from DCD donors after treated with N₂, Xenon, Argon alone and in combination with dexmedetomidine.

FIG. 11A shows a graph of IL-1β expression in rat renal grafts from DCD donors after treated with N₂, Xenon, Argon alone and in combination with dexmedetomidine.

FIG. 11B shows a graph of TNF-α expression in rat renal grafts from DCD donors after treated with N₂, Xenon, Argon alone and in combination with dexmedetomidine.

FIG. 11C shows a graph of HMGB-1 expression in rat renal grafts from DCD donors after treated with N₂, Xenon, Argon alone and in combination with dexmedetomidine.

FIG. 11D shows a graph of Creatinine expression in rat renal grafts from DCD donors after treated with N₂, Xenon, Argon alone and in combination with dexmedetomidine.

FIG. 11E shows a graph of Urea expression in rat renal grafts from DCD donors after treated with N₂, Xenon, Argon alone and in combination with dexmedetomidine.

FIG. 12A shows CD68+ stains of rat renal grafts from DCD donors after treated with N₂, Xenon, Argon alone and in combination with dexmedetomidine.

FIG. 12B shows a graph of CD68+ macrophage expression in rat renal grafts from DCD donors after treated with N₂, Xenon, Argon alone and in combination with dexmedetomidine, based on the stains of FIG. 12A.

FIG. 12C shows MTS stains of rat renal grafts from DCD donors after treated with N₂, Xenon, Argon alone and in combination with dexmedetomidine.

FIG. 12D shows a graph of MTS expression in rat renal grafts from DCD donors after treated with N₂, Xenon, Argon alone and in combination with dexmedetomidine, based on the stains of FIG. 12C.

### DETAILED DESCRIPTION

Using a rat hypothermic machine perfusion model, we have found that exposing xenon, argon and DEX alone or in combinations of xenon or argon with DEX to ex vivo renal grafts from brain death or cardiac arrest donors prior to engraftment can prevent organ graft injury histologically and functionally.

Xenon typically costs more than argon, and thus argon could be considered as a cost-effective alternative to xenon. However, in an ex vivo machine perfusion setting for marginal donor graft, it is anticipated that even without using a recycling/recirculating technique for administration of xenon, not more than 50 liters will be used for a about cost of $785 US Dollars (as of 2019) per human graft. Argon, on the other hand, would cost only 10% of xenon. This will represent a small fraction of the total costs of renal transplantation. DEX has been approved for use in Europe as a sedative agent clinically and its supplementation to preserving solution saturated with xenon or argon gas is a low cost but higher efficient strategy in enhancing the preserving outcomes.

The protective properties of Dexmedetomidine (Dex) are complemented by its safety profile. Dex is clinically used as an anesthetic agent and exhibits the ideal properties of α2-adrenoceptor agonists, including hemodynamic control, cardioprotection and mild diuretic properties [33].

Taken together, Dex treatment, combined with xenon and/or argon, is a cost-effective intervention in attenuating organ graft injury during prolonged cold preservation. The teachings herein have the significant clinical benefits of enhancing the pool of marginal donor organs. As used herein the term “marginal” refers to organs that are not, in the absence of treatments described herein, suitable for elderly donors, diseased donors, and, donors after cardiac death (DCD) and/or after brain death (DBD).

The following compounds, dosages, and treatment protocols described in the examples below can be used alone or in combination to preserve organs. These compounds, methods, and combinations thereof, can be used with any suitable organ preserving solution, non-exclusively including: UW Solution, Soltran Solution, and Collins Solution.

Methods herein can be administered to the organ ex vivo and/or in vivo to the donor or to the recipient after transplantation. In vivo treatment, whether to the donor before transplantation or to the recipient after transplantation, can be performed by any suitable means, such as direct application to the organ while the donor/recipient surgical site is still open, or through oral administration, using any suitable administration method. The ex vivo treatments described herein can be performed using any suitable preservation solution, non-exclusively including: UW Solution, Soltran Solution, and Collins Solution.

The compounds used to preserve organs, are preferably combined in combination but can alternatively be administered separately within a short time frame, e.g., 1-4 hours. The term “combination” herein refers both of the above embodiments. Preferred compound ranges in solution are as follows. Dexmedetomidine is preferably used between 0.05-0.2 nM, and more preferably around 0.1 nM. Oxygen is preferably used at about 25-35%, more preferably about 30%. When Oxygen is utilized, one or more noble gases can be combined in about 55-75%, more preferably 65%. When two noble gases are used, there ranges are preferably 35-45% argon (more preferably 40%), and 25-35% xenon (more preferably 30%). CO₂ can be combined with the above combination between about 2-10% (more preferably 5%).

In certain embodiments, the organ treating combination can be in a gas phase, and also exclude Dexmedetomidine. This gas combination could be useful for eye coronal preservation, for example. This combination can, non-exclusively include about 25-35% Oxygen, 35-45% argon, and 25-35% xenon.

### EXAMPLES

DCD Donor and Ex Vivo Graft Preservation Model

Inbred adult male Lewis rats (LEW, RT1¹) weighing 225-250 g were purchased from Harlan, UK and bred in temperature- and humidity-controlled cages in a specific pathogen-free facility at the Chelsea-Westminster Campus, Imperial College London. All animal procedures were carried out in accordance with the United Kingdom Animals (Scientific Procedures) Act of 1986. For cardiac arrest model (DCD donor) in anaesthetized rats [34], anticoagulation was accomplished by injecting 250 U Heparin in 1 ml saline via the penile vein. Five minutes after heparinization, a laparotomy was performed through a midline incision. A thoracotomy was performed followed by induction of cardiac arrest by external compression of the heart for 5 min. After induction of cardiac arrest, the aorta was closed using a vascular clamp rostral from the heart. The thoracotomy wound was covered with gauze and kept moist with 0.9% NaCl. After 40 minutes in DCD donors, the entire graft, lung or kidney, in the donor was isolated and excised. Lung grafts were flushed through the main pulmonary artery and stored at 4° C. for 16 hours with either control UW solution or UW with Dex (0.1 nM) solution.

Rat Renal Transplantation Surgery

Rat renal transplantation was performed. Rat donor kidneys were transplanted orthotopically into recipients by using standard microvascular techniques. Briefly, the donor left kidney, aorta, and inferior vena cava were carefully exposed, and the kidney graft was then extracted, flushed, and stored in 4° C. heparinized Soltran preservative solution (Baxter UK, Newbury, UK). After the specified period of cold ischemia, the recipient's left kidney was extracted, and the donor renal vein was connected to the recipient renal vein through end-to-end anastomosis. The arterial anastomosis between the donor aortic patch was connected to the recipient aorta in an end-to-side manner. Urinary reconstruction was performed by ureter-to-bladder anastomosis. The total surgical ischemia time was restricted to <45 min. The contralateral kidney was removed immediately after engraftment.

Gas Exposure Ex Vivo

The gas (either 70% Xe or 70% N₂, with 5% CO₂ balanced with O₂) was pumped into the SOLTRAN™ preservative solution for 20 min in an aseptic container at 2 L/min. Gas concentrations of Xe and O₂ were constantly monitored by a Xe monitor (model 439Xe; AIR PRODUCTS™, Bradford, UK) and a DATEX™ monitor (DATEX-OHMEDA®, Bradford, UK). After the presaturation period, the grafts were placed into a container, and the container was sealed. The kidney was then stored in gas-saturated solution for 24 and 48 h at 4° C.

Administration of Atipmazeole and Nrf-2 siRNA to Donor Animals

Nrf-2 siRNA or scrambled siRNAs (negative control) (QIAGEN®) were dissolved in siRNA suspension buffer and further diluted in RNase-free PBS before use. siRNA targeting rat Nrf-2 (sc-37030, SANTA CRUZ BIOTECHNOLOGY®, USA) was administered through hydrodynamic tail vein injection. Nrf-2 or scrambled siRNA (200 mg in 10 ml of PBS) was rapidly injected (within 30 s) via a tail vein under anaesthesia and allow to recover for 24 h before the experiment. Atipamezole (α2-adrenergic antagonist, SIGMA-ALDRICH®, St. Louis, Mo., USA, 250 μg/kg, i.p.) was administered 10 minutes graft extraction[35].

Haematoxylin and Eosin Staining

Lung or kidney grafts were fixed in 4% parafamydehyde and paraffin. Sections of 5-μm thickness were taken from the kidney specimens and haematoxylin & eosin (H&E) staining was carried out. Lung cell morphology in each graft (10 fields in the cortex at ×20 magnifications) was evaluated by an observer blinded to the treatment using an OLYMPUS™ (Watford, UK) BX4 microscope under constant exposure level. The score for each field was calculated from the sum score of 10 areas chosen at a random. For the lung sections [36], the injury was categorised into Grade 0: normal appearance, negligible damage; Grade 1: mild moderate interstitial congestion and neutrophil leukocyte infiltrations; Grade 2: perivascular oedema formation, partial destruction of pulmonary architecture and moderate cell infiltration; Grade 3: moderate lung alveolar damage and intensive cell infiltration; Grade 4: severe cell infiltration and severe destruction of the pulmonary architecture.

For kidney sections[37], a mean score was calculated from the analysis of 10 cortical tubules per H&E-stained cross section (10 sections/kidney), according to a modified scale: 0, no damage; 1, mild damage: rounded epithelial cells and dilated tubular lumen; 2, moderate damage: flattened epithelial cells, loss of nuclear staining, and substantially dilated lumen; 3, severe damage: destroyed tubules with no nuclear staining of epithelial cells; and 4, complete loss of renal structure.

Immunohistochemistry

For in vivo fluorescence or DAB staining, 25-μm frozen lung sections were incubated with rabbit anti-Rip1 (1:200, SANTA CRUZ BIOTECHNOLOGY®), rabbit anti-Rip3 (1:200, SANTA CRUZ BIOTECHNOLOGY®), mouse anti-HMGB-1 (1:200, Abcam), Goat anti-TLR-4 (1:200, SANTA CRUZ BIOTECHNOLOGY®), rabbit anti-Nrf-2 (1:200, SANTA CRUZ BIOTECHNOLOGY®), mouse anti-SOD-1 (1:200, Abcam), mouse anti-NQO-1 (1:200 Abcam), rabbit anti-3-nitrotyrosine (1:200, Abcam) and rabbit anti-4-hydroxynonenal (1:200, Abcam) at 4° C. overnight. After washing with PBST, the slides were incubated with fluorochrome-conjugated secondary antibodies (MILLIPORE™, UK). For double-labelled immunofluorescence, lung samples were incubated with the first primary antibody overnight, followed by the first secondary antibody, and then the second primary antibody and the second secondary antibody. The slides were counterstained with nuclear dye DAPI and mounted with VECTASHIELD® Mounting Medium (Vector lab, USA). Sections were examined using an OLYMPUS™ (Watford, UK) BX4 microscope under constant exposure level. Immunofluorescence was quantified using ImageJ (National Institutes of Health, Maryland, USA) and the background was subtracted. Ten representative regions per section (in vivo) or field (in vitro) were randomly selected by an assessor blinded to the treatment groups. Values were then calculated as percentages of the mean value for naïve controls and expressed as percentage fluorescence intensity.

TUNEL Staining

Lung alveolar cell death was detected by the in situ TUNEL assay (MILLIPORE™) according to the manufacturer's instructions. TUNEL nuclei were visualized by green FITC fluorescence.

Enzyme-Linked Immunosorbent Assay (ELISA)

Tumor necrosis factor-α (TNF-α) in the culture medium were detected by ELISA (Human TNF-α ELISA kits, INVITROGEN®, UK). Rat lung tissue and serum TNF-α were measured by ELISA (Rat TNF-α ELISA kits, INVITROGEN®, UK).

Determination of Total Glutathione (GSH and GSSG)

Total glutathione (GSH and GSSG) was measured in lung homogenates using glutathione assay kit (SIGMA-ALDRICH®, UK).

Masson Trichrome Staining (MTS)

MTS was performed on paraffin-embedded tissue according to the manufacturer's instructions (MTS kit; SIGMA-ALDRICH®, Ltd., Poole, UK). The amount of collagen deposition (percentage of MTS-stained area) was then digitally quantified with ImageJ software (U.S. National Institutes of Health, Bethesda, Md., USA).

Renal Function

Blood samples were collected when the animals were euthanized. After centrifugation, serum urea and creatinine concentrations were measured with an AU2700 analyzer (OLYMPUS).

Western Blot Analysis

The graft cortices were mechanically homogenized in lysis buffer and centrifuged at 3000 g for 30 min at 4° C., and the supernatant was collected. The total protein concentration in the supernatant was quantified by the Bradford protein assay (Bio-Rad, Hemel Hempstead, UK). The protein extracts (40 μg/sample) were heated for 10 min at 95° C. and denatured in sodium dodecyl sulfate (SDS) sample buffer (INVITROGEN®, Paisley, UK), the samples were loaded on a NuPAGE 4 to 12% Bis-Tris gel (INVITROGEN®) for electrophoresis and then transferred to a PVDF membrane. The membrane was treated with blocking solution [5% nonfat dry milk in Tris-buffered saline with 0.1% Tween-20 (TBST)] for 2 h and probed with the following primary antibodies: rabbit anti-HSP 70 (1:1000, SANTA CRUZ BIOTECHNOLOGY®) and rabbit anti-Bcl-2 (1:1000, Abcam) in TBST overnight at 4° C., followed by HRP-conjugated secondary antibody for 1 h. The loading control was α-tubulin (1:10,000, SIGMA-ALDRICH®). The membrane was washed with TBST for 5 min 3 times and visualized with an enhanced chemiluminescence (ECL) system (SANTA CRUZ)BIOTECHNOLOGY®. The protein bands were captured with an image processor (GeneSnap; SYNGENE®, Cambridge, UK), and the intensity of the bands corresponding to the protein expression level was measured with GENETOOLS® software (SYNGENE®) and normalized with α-tubulin and expressed as a ratio to the control for data analysis.

Statistical Analysis

All numerical data were expressed as mean±standard deviation (SD). Data were analysed using the two-tailed Student's t-test, or analysis of variance (ANOVA) followed by Kruskal-Wallis non-parametric (scoring) or Newman-Keuls (measurement) test for comparisons when appropriate. Animal survival analysis was performed using Kaplan-Meier survival estimates, and statistical significance was analyzed by the log-rank test (GRAPHPAD PRISM® 5.0; GRAPHPAD® Software). A p value<0.05 was considered to be statistically significant.

### Example 1: Exposure of Dexmedetomidine, in Ex Vivo Grafts, Reduced Kidney Graft Damage Associated with Ischemia-Reperfusion Injury

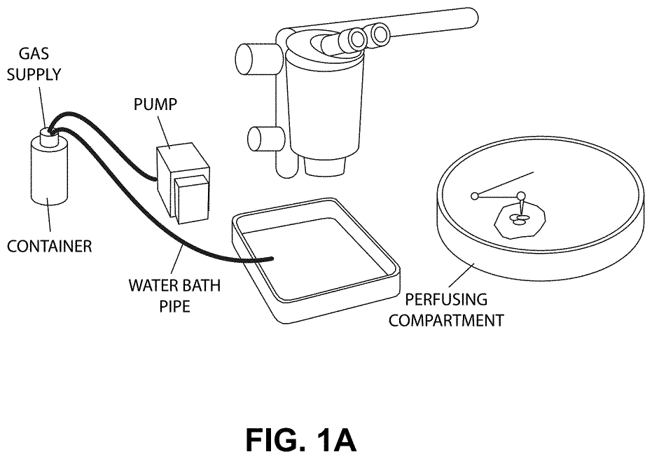

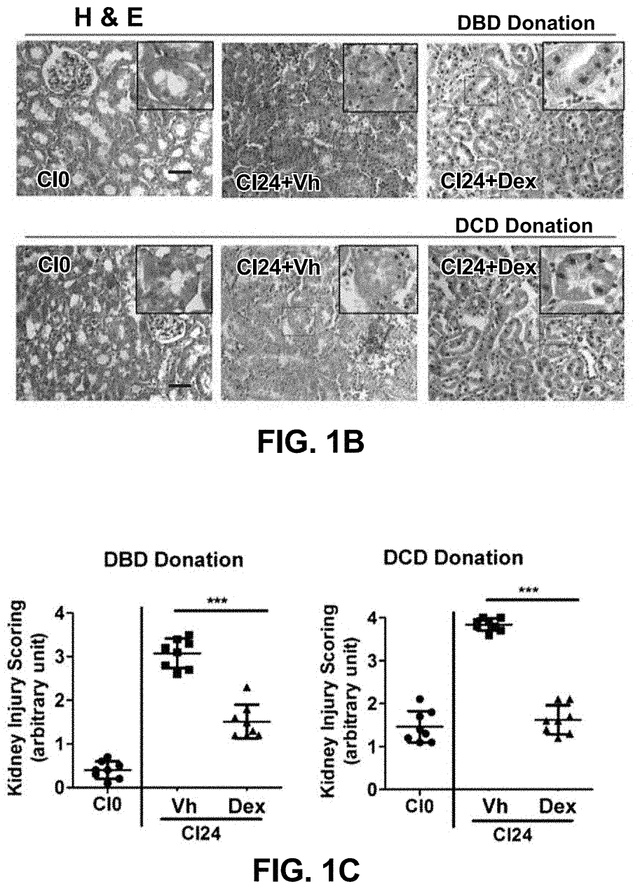

Machine perfusion has been taken as a standard organ preserving procedure [18]. A rat renal graft machine perfusion model was developed, (see FIG. 1B) to simulate the renal graft preservation process. A series of experiments were conducted using the Fischer-to-Lewis allogeneic renal transplant model. Grafts from donors after brain death (DBD) or cardiac arrest (DCD) were used [38]. The preserving solution was saturated with dexmedetomidine at 0.1 nM[32]. The grafts were extracted and then machine-perfused with UW solution at 4° C.[18] with a flow rate of 1.5-2 ml/min [39] for 4 hours and then kept in the preserving solution until 24 hours. Grafts were then transplanted into Lewis recipient immediately following extraction (cold-ischemia 0 hr), or stored in preservative solution for 24 hr (cold-ischemia 24 hr), The orthotopic renal transplantation into Lewis recipients was conducted and their contralateral kidneys were removed at the end of surgery [22]. The recipient received cyclosporine A (5 mg/kg/day intramuscular injection per day) for 10 days to prevent acute immune rejection [21, 23].

The data showed that ex vivo exposure to dexmedetomidine preserved the renal graft architecture during cold preservation (FIGS. 1B and 1C) reduced necroptosis. With respect to FIGS. 1A-1C show Perfusion apparatus and morphological change after Dexmedetomidine during ex vivo organ preservation. FIG. 1A shows a UP-100 perfusion system in the applicant's laboratory. The system is built up with all elements (pump, tubing and glass container) purchased from Harvard apparatus (Kent, UK) and a renal graft from a DCD donor was perfused. The glass container was equipped with pipes connected to a water bath which maintains the desired temperate. Dexmedetomidine (Dex) exposure reduced tissue injury in the renal cortex and preserved renal morphology during cold storage. FIGS. 1B and 1C show results from fischer rat renal grafts from DBD donation or DCD donation that were stored in UW preservative solution at 4° C., saturated with Dex for up to 24 hrs (Cold ischemia CI 24 hr), grafts harvested from donor (cold ischemia CI 0 hr) serves as control. C and D) Renal morphology was assessed by H&E staining and evaluated by an injury scoring system. n=8, Scale bar=50 μm. Data are expressed as mean±sd. ***P<0.001.CI: cold ischemia, Vh: Vehicle, Dex: Dexmedetomidine.

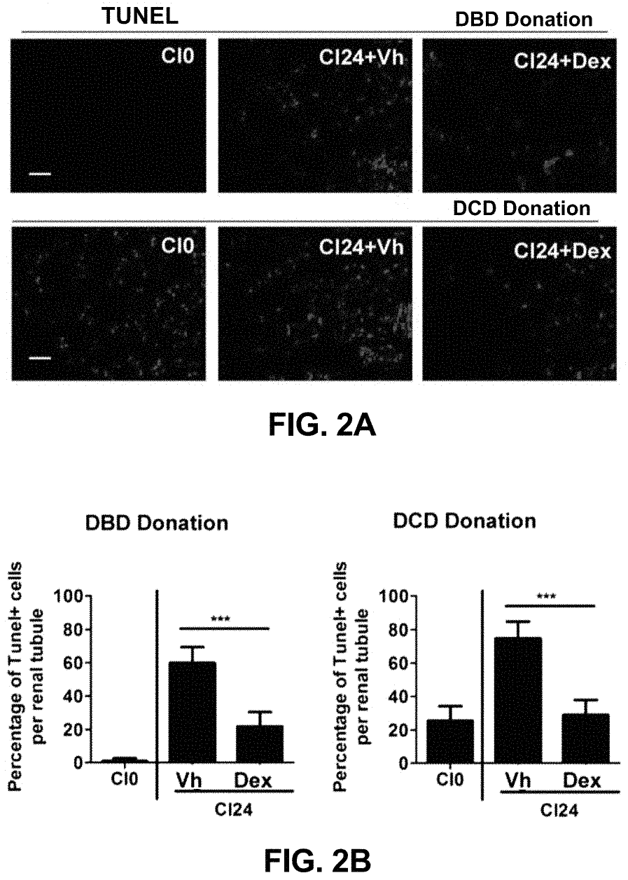

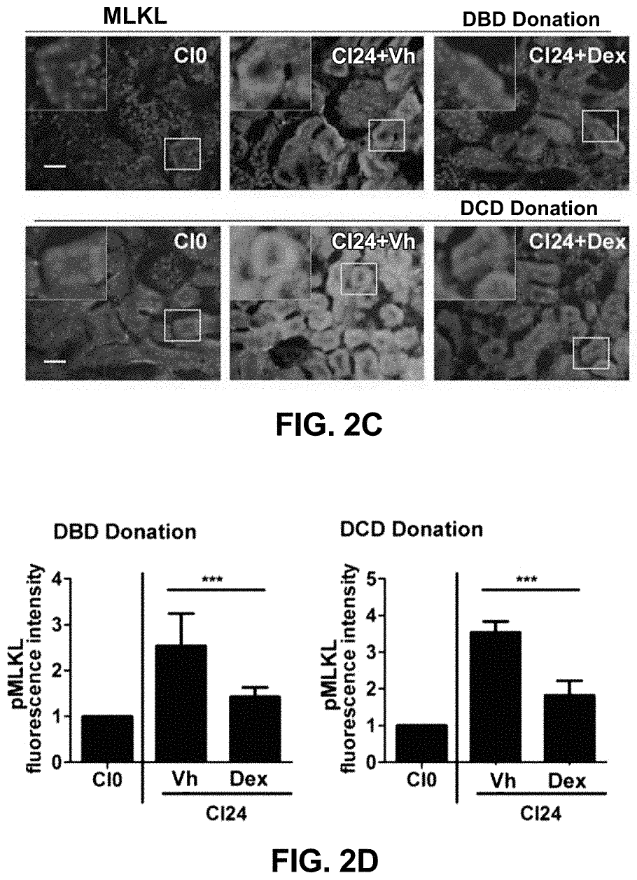

FIGS. 2A-D show Dexmedetomidine (Dex) exposure reduced tissue injury in the renal cortex and suppressed necroptosis during cold storage. FIGS. 2A-2D show TUNEL cell death staining, MLKL: marker of necroptosis. DBD donation or DCD donation were stored in UW preservative solution at 4° C., saturated with Dex for up to 24 hrs (Cold ischemia CI 24 hr), grafts harvested from donor (cold ischemia CI 0 hr) serves as control. Cell death was assessed by TUNEL staining (FIGS. 2A and 2B, Green Fluorescence indicates TUNEL positive cells). n=8. C and D) Necroptosis was assessed by expression of MLKL (FIGS. 2C and 2D, Green Florence). Nucleus was counterstained with DAPI. n=6. Scale bar=50 μm. Data are expressed as mean±sd. *P<0.05, **P<0.01. ***P<0.001. CI: cold ischemia, Vh: Vehicle, Dex: Dexmedetomidine.

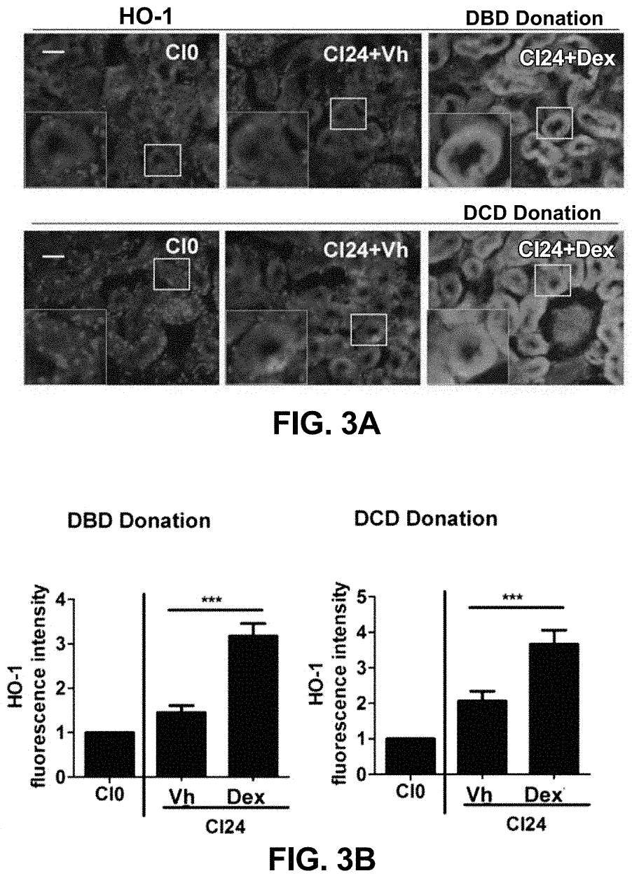

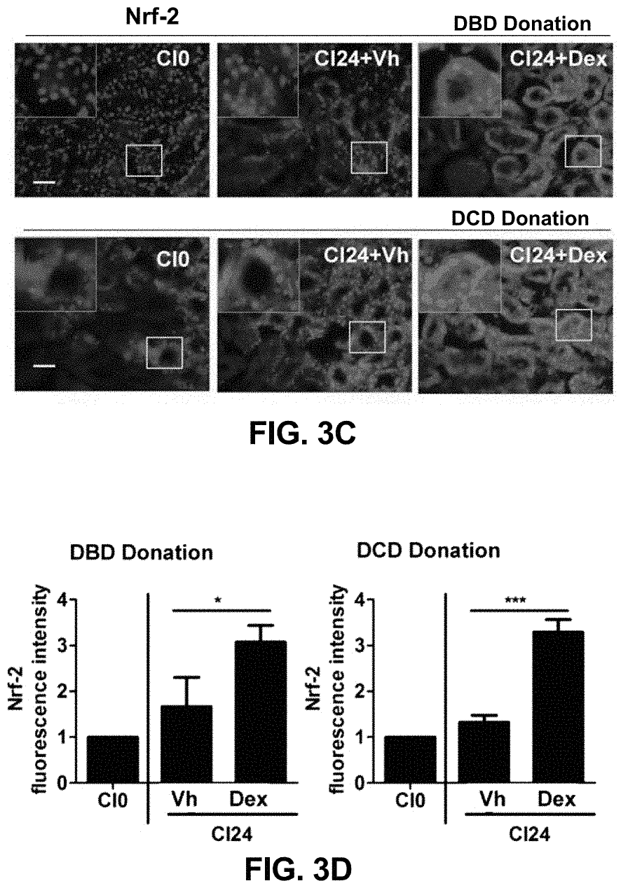

Heme oxygenase 1 (HO-1) and The nuclear factor erythroid 2-related factor 2 (Nrf2) were significantly increased after treatment and could mediate the protective effects FIGS. 3A-D show Dexmedetomidine (Dex) exposure reduced tissue injury in the renal cortex and preserved renal morphology during cold storage. Fischer rat renal grafts from DBD donation or DCD donation were stored in UW preservative solution at 4° C., saturated with Dex for up to 24 hrs (Cold ischemia CI 24 hr), grafts harvested from donor (cold ischemia CI 0 hr) serves as control. Expression of HO-1 (Green Fluorescence A and B) and Nrf-2 (Red Fluorescence, C and D) was assessed by Immunofluorescence staining (A and B, Green Florence). Nucleus was counterstained with DAPI. n=6. Scale bar=50 μm. Data are expressed as mean±sd. *P<0.05, ***P<0.001. CI: cold ischemia, Vh: Vehicle, Dex: Dexmedetomidine.

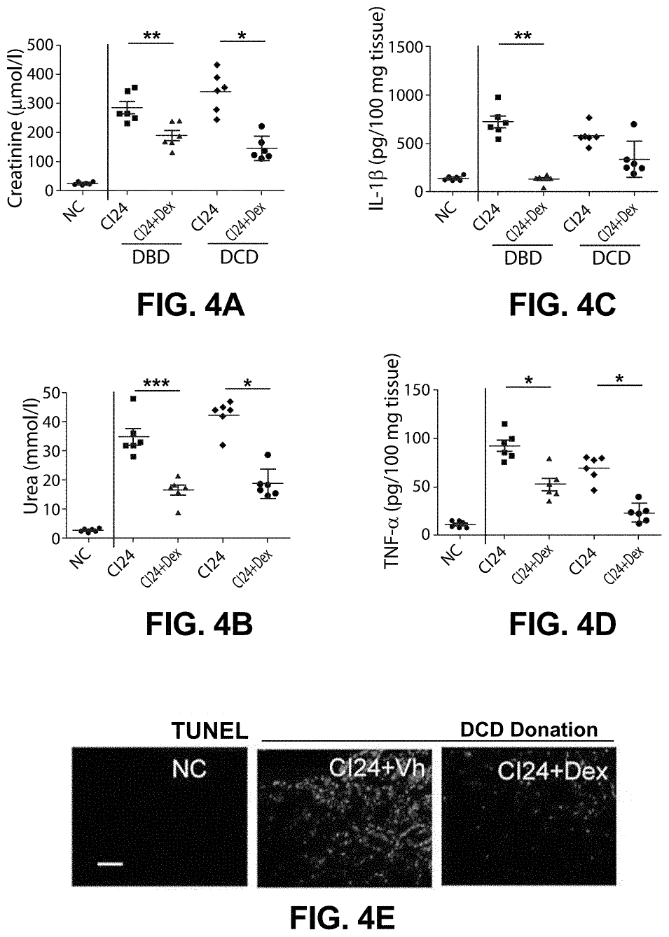

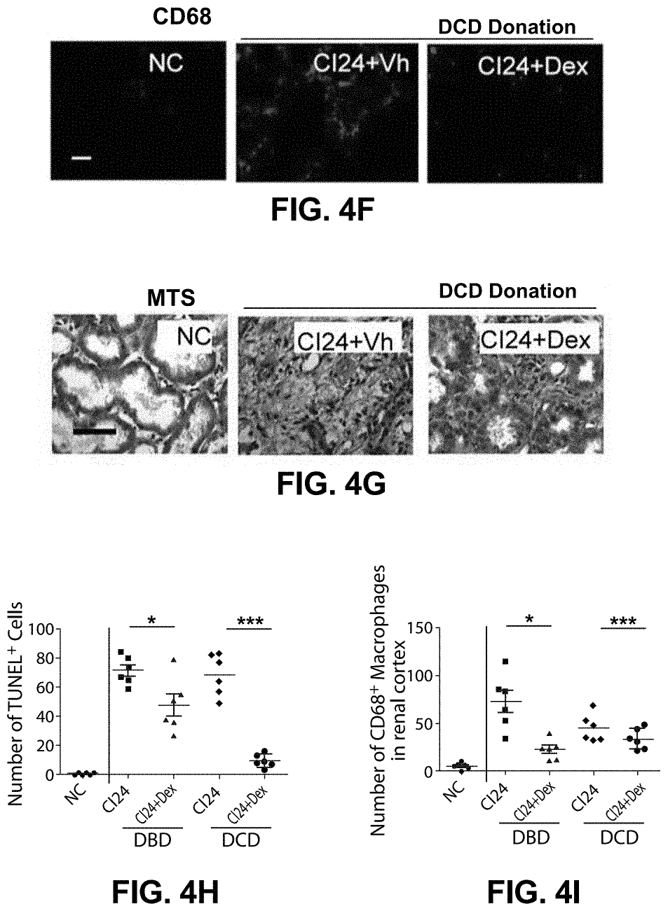

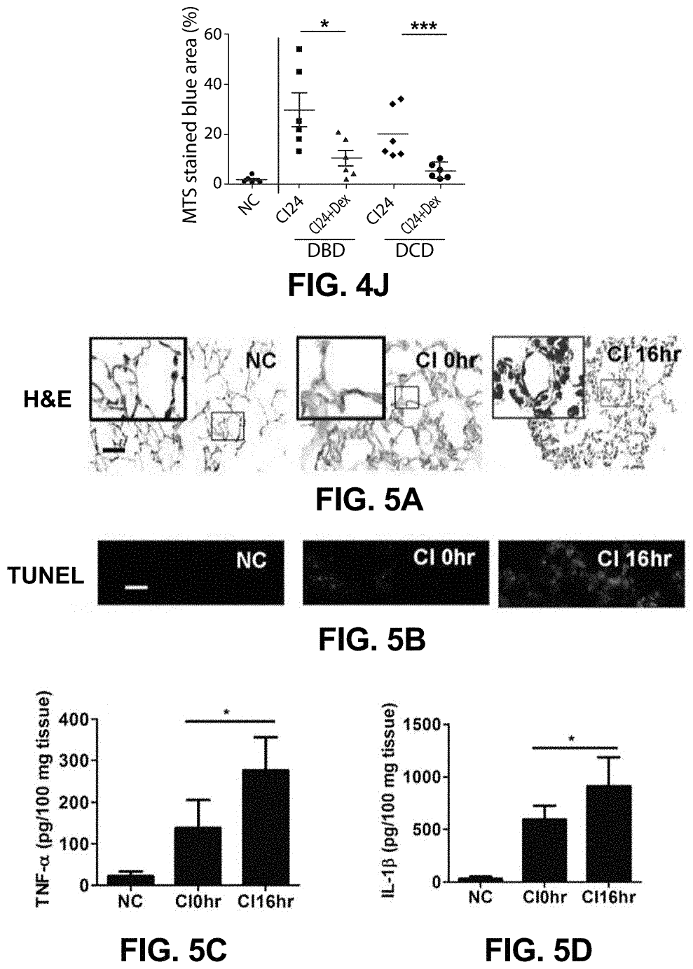

On day 1 after the surgery, Dex treatment induced a quick functional recovery. FIGS. 4A and 4B show Dexmedetomidine (Dex) exposure preserved renal function, reduced graft cell death, inflammation and fibrosis after transplantation. With respect to FIGS. 4A-4J, Fischer rat renal grafts from DBD donation or DCD donation were stored in UW preservative solution at 4° C., saturated with DEX for up to 24 hrs (Cold ischemia CI 24 hr), grafts harvested from donor (cold ischemia CI 0 hr) serves as control. (A and B) Serum creatinine and urea concentration were analyzed 24 hours after transplantation (n=6). (C and D) Tissue cytokine TNF-α and IL-1β concentration was assessed by ELISA. (E) TUNEL staining of renal tubules in renal cortices 24 hours after transplantation. Scale bar=50 μm. In DCD grafts, Infiltrated CD68+ macrophages (Red fluoresce; F) and renal fibrosis (blue MTS staining; G) on day 8 after transplantation were assessed. In both DCD and DBD grafts, (H) Analysis of the percentage of TUNEL+ tubular cells in renal cortices. (I) The number of CD68+ macrophage, and (J) the area of MTS staining. Data is expressed as mean±SD (n=6). (*p<0.05, **p<0.01 and ***p<0.001). CI: cold ischemia, Vh: Vehicle, Dex: Dexmedetomidine.

Dex treatment suppressed the inflammation (FIGS. 4C and 4D), with reduced tissue level of cytokine IL-1β and TNF-α. Cell death (Number of TUNEL+ cells) were reduced (FIGS. 4E and 4H). Macrophage infiltration (Number of CD68+ cells) and renal fibrosis (MTS staining) were attenuated on day 16 after surgery (FIGS. 4F, 4J, 4I, and 4J). The preliminary results provide unique insight into the molecular mechanisms of necroptosis that represent potential therapeutic targets in kidney transplantation. Dexmedetomidine conferred significant protection in ex vivo renal allograft from cardiac arrest donation.

### Example 2: Exposure of Dexmedetomidine, in Ex Vivo Grafts, Reduced Lung Graft Damage Associated with Cold Ischemic Injury

Prolonged Cold Preservation Caused Necroptosis and Enhanced Release of HMGB-1 in Lung Grafts.

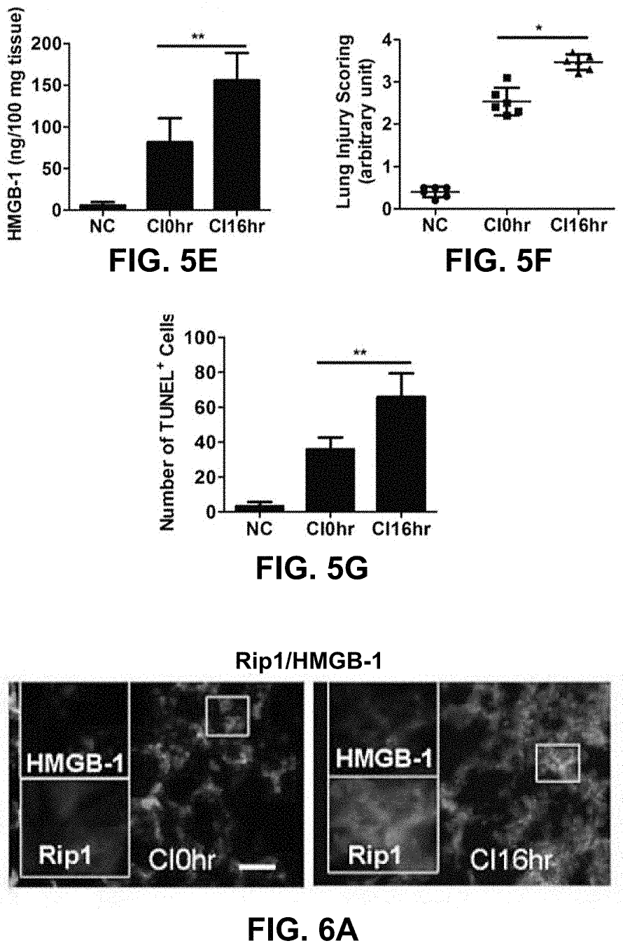

In order to ascertain whether ischemic renal grafts promote the development of acute lung injury, histological analysis on lung grafts was performed (FIGS. 5A and 5B). Our findings demonstrate that prolonged cold preservation resulted in severe lung graft injury, as evidenced by parenchymal lung damage, nuclear fragmentation, and an increase in lung injury score. An increase in TUNEL assay (FIGS. 5B and 5G) indicates an increase in cell death in lung alveolar cells following cold preservation. The concentration of lung tissue cytokines was assessed by ELISA, with comparison of NC, CI 0 hr and CI 16 hr, and the findings demonstrate that hypothermic-ischemic injury causes a significant increase in lung tissue cytokines production, including TNF-α, IL-1β, and HMGB-1 (FIGS. 5D and 5E). With respect to FIGS. 5A-5G, Lewis rat lung grafts were extracted after cardiac death and stored in 4° C. UW solution for 0 or 16 hours (lung graft cold ischemia CIO or 16 hr). Normal lung grafts served as the naive control (NC). (FIG. 5A) Histology (haematoxylin and eosin staining) of the lung graft (FIG. 5B) Lung tissue cell death was detected by the in situ TUNEL assay. Concentration of (FIG. 5C) TNF-α, (FIG. 5D) IL-1β, and (FIG. 5E) HMGB-1 in lung graft tissue, were assessed by ELISA. (FIG. 5F) Lung morphology was evaluated by a lung injury scoring system. (FIG. 5G) Number of TUNEL+ cells. Scale bar: 50 mm. Data are expressed as mean±SD (n=6), (**p<0.01 and ***p<0.001). NC: naïve control, CI: Cold ischemia. H&E, haematoxylin & eosin; TNF, tumour necrosis factor; IL, interleukin; HMGB, high mobility group box 1 protein; ELISA, enzyme-linked immunosorbent assay; TUNEL, Terminal deoxynucleotidyl transferase (TdT) dUTP nick-end labelling.

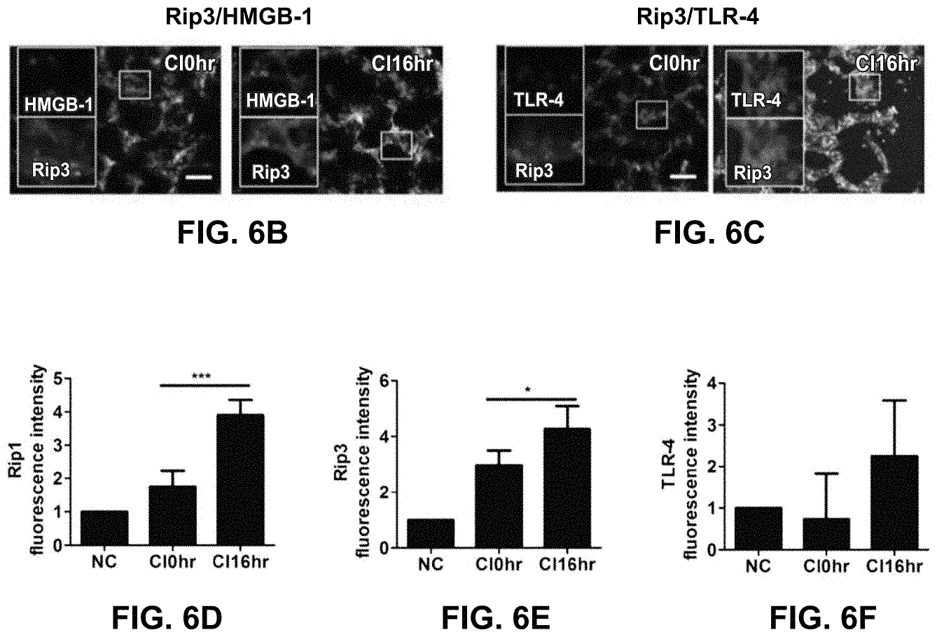

The expression of necroptosis markers RIPK1 and RIPK3 was significantly increased (FIGS. 6A-6E). Necroptosis markers were found to co-localize with HMGB-1 release and TLR-4 (FIGS. 6F and 6C), indicating that HMGB-1 is released and subsequently activates TLR-4 pathways in necroptotic cells. With respect to FIGS. 6A-6F, Lewis rat lung grafts were extracted after cardiac death and stored in 4° C. UW solution for 0 or 16 hours (lung graft cold ischemia CIO or 16 hr). Normal lung grafts served as the naive control (NC). Dual labelling of (FIG. 6A) Rip-1 (red) and HMGB-1 (green), (FIG. 6B) Rip-3 (red) and HMGB-1 (green) and (FIG. 6C) Rip-3 (red) and TLR-4 (green) in lung tissue. Fluorescent intensity of (FIG. 6D) RIPK1, (FIG. 6E) RIPK3 and (FIG. 6F) TLR-4 in lung tissue. Nuclei were counterstained with 4′,6-diamidino-2-phenylindole (DAPI) (blue). Scale bar: 50 μm. Data is expressed as mean±SD (n=6), (*p<0.05, **p<0.01 and ***p<0.001). HMGB, high mobility group box 1 protein; CI, cold ischaemia; NC, naïve control; TLR-4, toll-like receptor 4.

Dex Treatment Suppressed Necroptosis and HMGB-1 Release in Lung Grafts.

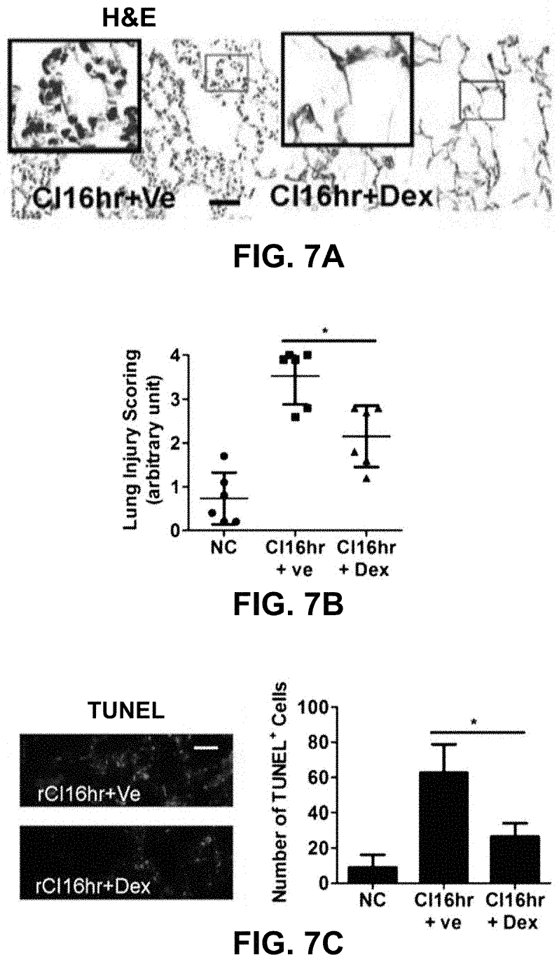

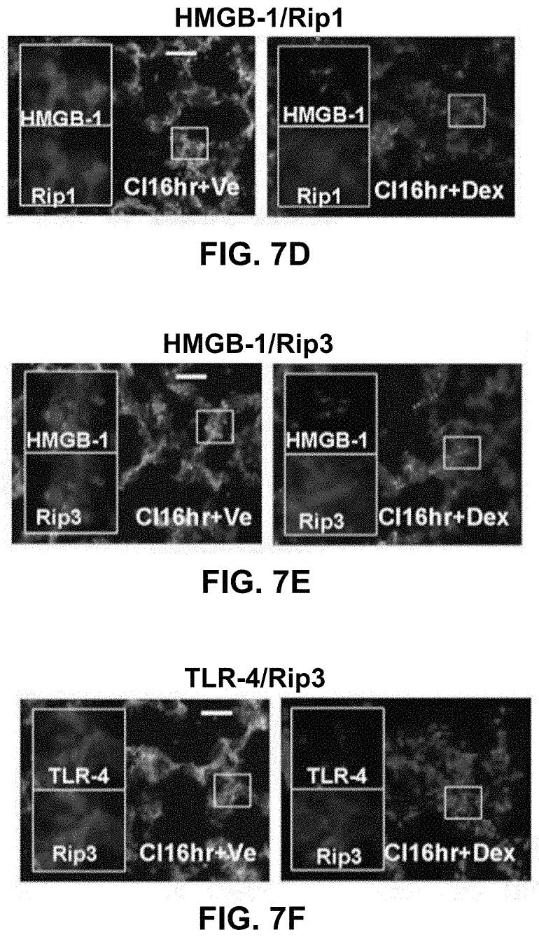

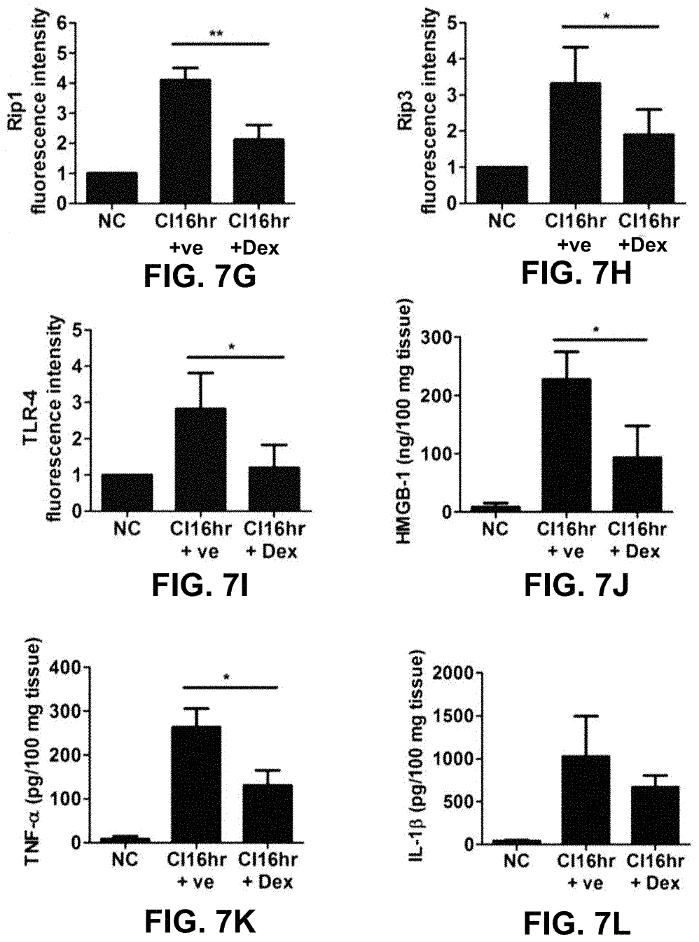

Lung grafts stored in Dex-saturated UW preservative solution at 4° C. showed marked improvement in morphology (FIGS. 7A and 7B) and reduced cell death (assessed by TUNEL staining, FIG. 7C). The expression of necroptosis markers RIP1 and RIPS was also significantly reduced (FIGS. 7D, 7E, 7G and 7H), in addition to a reduction in HMGB-1 release and TLR-4 activation (FIGS. 7F and 7I). As a result, the concentration of tissue inflammatory cytokines, HMGB-1, TNF-α and IL-1β, was significantly reduced (FIGS. 7J-7L). With respect to FIGS. 7A-7L, Lewis rat lung grafts were extracted after cardiac death and stored in 4° C. UW solution saturated with Dex (0.1 nM) or without Dex (Vehicle) for 16 hours (lung graft cold ischemia CIO 16 hr). (FIG. 7A) Lung morphology was assessed by H&E staining, (FIG. 7B) Lung morphology was evaluated by a lung injury scoring system. (FIG. 7C) Lung tissue cell death was detected by the in situ TUNEL assay. Number of TUNEL+ cells. Dual labelling of (FIG. 7D) Rip-1 (red) and HMGB-1 (green), (FIG. 7E) Rip-3 (red) and HMGB-1 (green) and (FIG. 7F) Rip-3 (red) and TLR-4 (green) in lung tissue. Fluorescent intensity of (FIG. 7G) RIPK1, (FIG. 7H) RIPK3 and (FIG. 7I) TLR-4 in lung tissue. Nuclei were counterstained with 4′,6-diamidino-2-phenylindole (DAPI) (blue). Concentration of (FIG. 7J) HMGB-1, (FIG. 7K) TNF-α and (FIG. 7L) IL-1β in lung graft tissue, were assessed by ELISA. Scale bar: 50 μm. Data is expressed as mean±SD (n=6), (*p<0.05, **p<0.01 and ***p<0.001). HMGB-1, high mobility group box 1 protein; CI, cold ischaemia; NC, naïve control; TLR-4, toll-like receptor 4.

Dex Treatment Activated Nrf-2 and Down-Stream Effectors NQO-1 and SOD-1

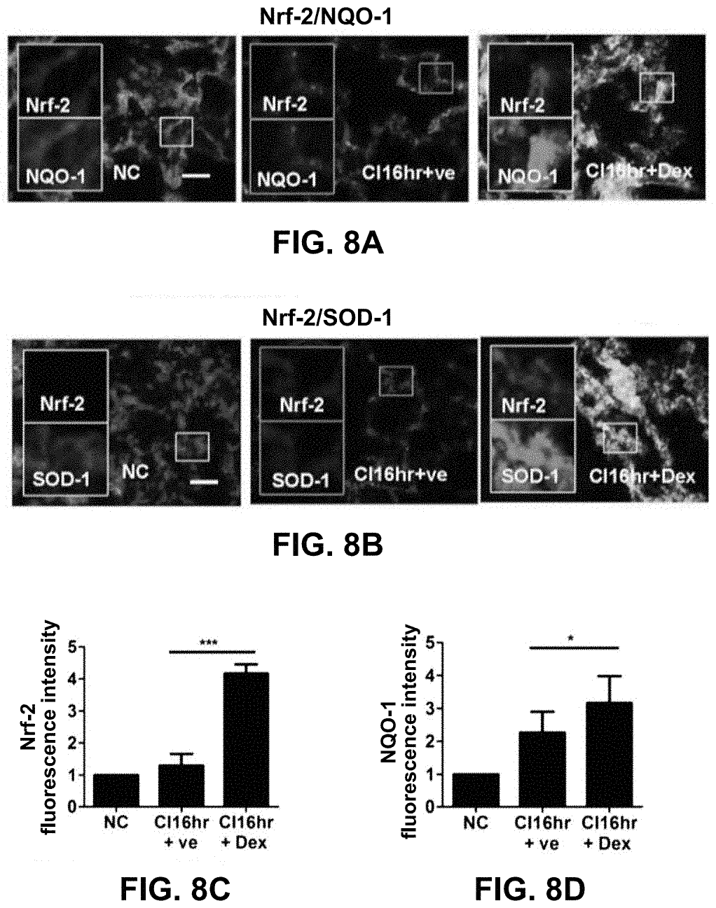

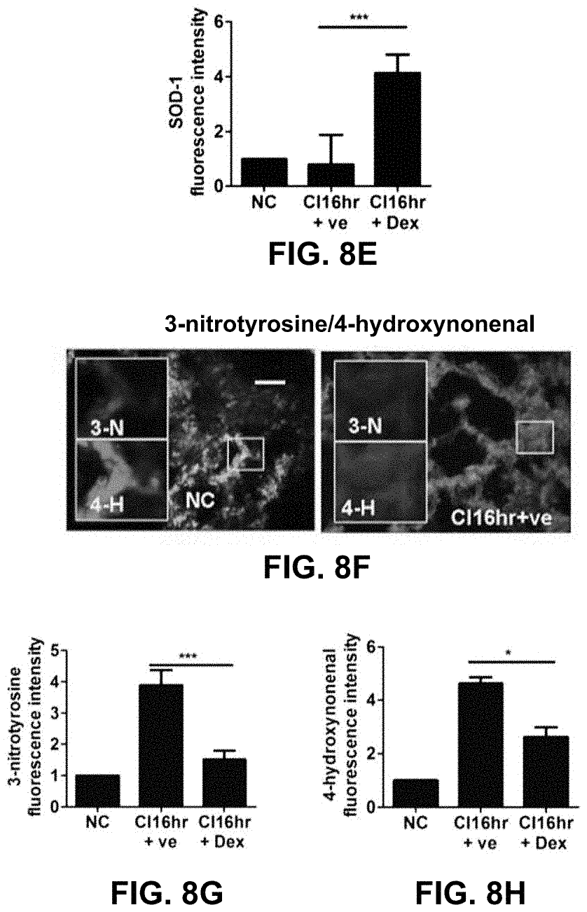

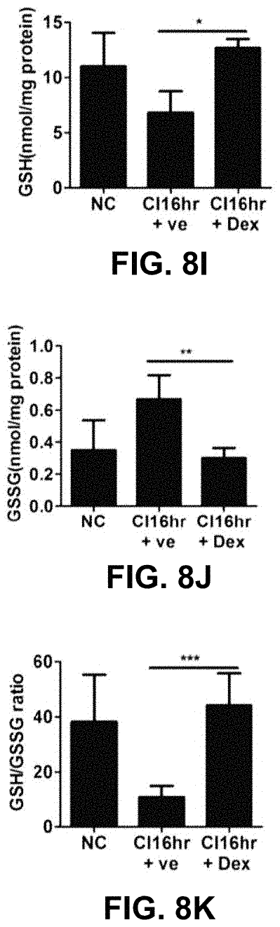

Nrf-2 and its downstream effectors, NQO-1 and SOD-1, are critical anti-oxidant enzymes involved in dampening the effects of the pro-inflammatory response during ischemia-reperfusion injury. Immunofluorescent labelling in lung alveolar cells was performed at CI 16 h in NC (normal lung grafts), lung grafts stored in UW preservative solution at 4° C., and lung grafts stored in Dex-saturated UW preservative solution at 4° C. Dual immunofluorescence was performed on lung grafts, Nrf-2 (red) and NQO-1 (green) staining (FIG. 4A), and Nrf-2 and SOD-1 (FIG. 8B). Lung grafts stored in Dex-saturated UW preservative solution experienced a significant increase in the expression of Nrf-2 (FIG. 8C; p<0.001), NQO-1 (FIG. 8D; p<0.05) and SOD-1 (FIG. 8E; p<0.001) at CI 16 h, indicating that lung grafts stored in Dex-saturated UW solution encounter increased antioxidant enzyme expression. 3-nitrotyrosine is a marker of nitrogen free radical species, whilst 4-hydroxynonenal is an unsaturated hydroxyalkenal that is produced by lipid peroxidation in cells; both are critical markers of oxidative stress in cells. Lung grafts stored in dex-saturated UW preservative solution experienced a significant reduction in the expression of both 3-nitrotyrosine (FIGS. 8F and 8G; p<0.001) and 4-hydroxynonenal (FIGS. 8F and 8H; p<0.05) compared to control group, indicating that Dex-saturated UW preservative solution reduces oxidative stress in lung grafts. Reduced GSH is a critical scavenger of reactive oxygen species, whilst its ratio with GSSG is a commonly used marker of oxidative stress. Lung grafts stored in Dex-saturated UW preservative solution experienced a significant increase in the expression of GSH at CI 16 h (FIG. 8I; p<0.05), and a significant decrease in GSSG at CI 16 h (FIG. 8J; p<0.01). Furthermore, lung grafts stored in Dex-saturated UW preservative solution also demonstrated a significant increase in the GSH/GSSG ratio (FIG. 8K; p<0.001) at CI 16 h. Together, these findings indicate an improvement in redox status and increased antioxidant activity within dex-saturated grafts. With respect to FIGS. 8A-8K, Lewis rat lung grafts were extracted after cardiac death and stored in 4° C. UW solution saturated with Dex (0.1 nM) or without Dex (Vehicle) for 16 hours (lung graft cold ischemia CIO 16 hr). Normal lung grafts served as the naive control (NC). Dual labelling of (FIG. 8A) Nrf-2 (red) and NQO-1 (green), (FIG. 8B) Nrf-2 (red) and SOD-1 (green) in lung tissue. Fluorescent intensity of (FIG. 8C) Nrf-2, (FIG. 8D) NQO-1 and (FIG. 8E) SOD-1 in lung tissue. (FIG. 8F) The expression of 3-nitrotyrosine and 4-hydroxynonenal was assessed with immunofluorescent labelling. Fluorescent intensity of (FIG. 8G) 3-nitrotyrosine and (FIG. 8H) 4-hydroxynonenal. Nuclei were counterstained with 4′,6-diamidino-2-phenylindole (DAPI) (blue). (FIG. 8I) lung tissue GSH level, (FIG. 8J) lung tissue GSSG level. (FIG. 8K). Lung tissue GSH to GSSG ratio. Scale bar: 50 μm. Data is expressed as mean±SD (n=6), (*p<0.05, **p<0.01 and ***p<0.001). NC: naïve control, rCI: renal graft cold ischemia. HMGB, high mobility group box 1 protein; CI, cold ischaemia; NC, naïve control; TLR-4, toll-like receptor 4. Nrf-2, nuclear factor erythroid 2-related factor 2; NQO-1, NAD(P)H: quinone acceptor oxidoreductase 1; SOD-1, superoxide dismutase 1; GSH, glutathione; GSSG, glutathione disulphide; NC, naïve control; CI, cold ischaemia.

Suppression of Nrf-2 or administration of atipamezole, attenuated Dex-mediated lung protection.

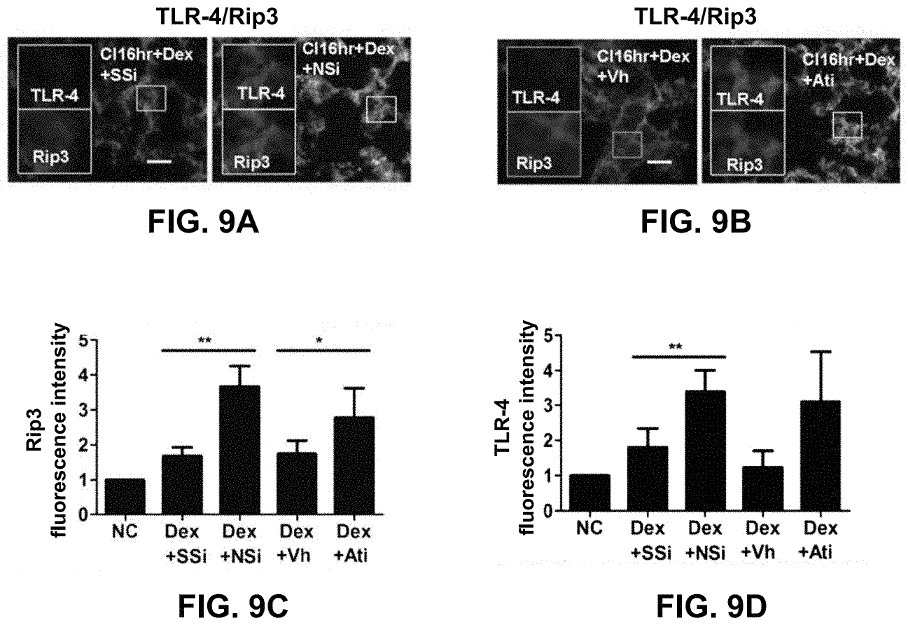

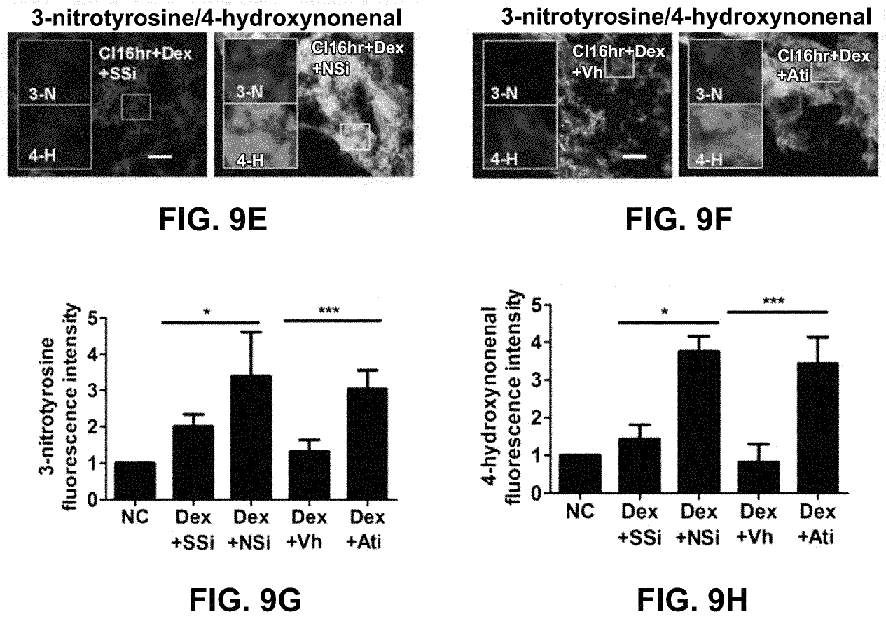

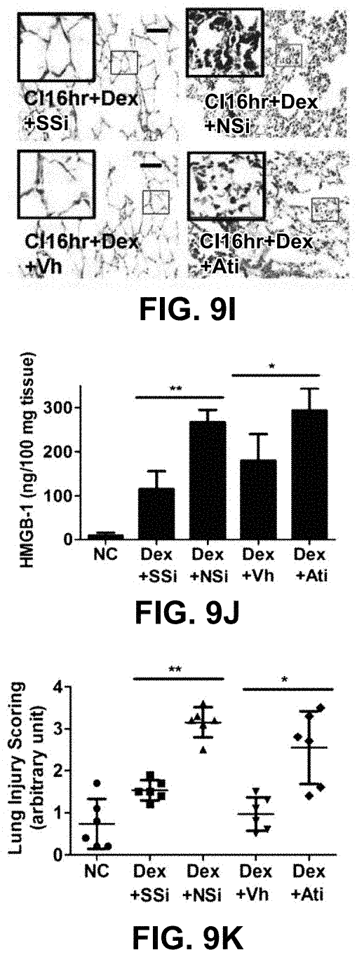

In order to further investigate the mechanisms underlying the protective effects of dexmedetomidine on lung grafts, Nrf-2 siRNA and atipamezole treatment was administered donor before lung grafts extraction. The grafts were subsequently stored in Dex-saturated UW solution. TLR-4 and RIP3 immunofluorescent labelling was performed in lung grafts, with and without Nrf-2 siRNA (FIG. 9A), and with and without atipamezole treatment (FIG. 9B). Administration of Nrf-2 siRNA and atipamezole were both associated with enhanced expression of RIP3 (FIG. 9C; p<0.01 and p<0.05, respectively) and TLR-4 (FIG. 9D; p<0.01). 3-nitrotyrosine and 4-hydroxynonenal immunofluorescent labelling was performed in lung alveolar cells at CI 16 h, with and without Nrf-2 siRNA or with and without atipamezole treatment (FIGS. 9E and 9F) at CI 16 h. Nrf-2 siRNA and atipamezole treatment both resulted in enhanced oxidative stress, as evidenced by a significant increase in 3-nitrotyrosine (FIG. 9G; p<0.05 and p<0.001, respectively) and 4-hydroxynonenal (FIG. 5H; p<0.05 and p<0.001, respectively) expression. Lung morphology deteriorated significantly with Nrf-2 siRNA and atipamezole treatment. Treatment of lung grafts with Nrf-2 siRNA and atipamezole both resulted in a significant increase in lung injury scoring (FIGS. 9I and 9K, p<0.01 and p<0.05, respectively). Together, these findings indicate that upregulation of the Nrf-2 and α2 adrenergic pathways are both critical to the protective effects of Dex on lung grafts. HMGB-1 expression was significantly increased in tissue stored in Dex-saturated UW solution and treated with Nrf-2 siRNA and atipamezole (FIG. 9J; p<0.01 and p<0.05), indicating that down-regulation of Dex-mediated anti-inflammatory pathways is associated with the promotion of pro-inflammatory DAMP pathways. With respect to FIGS. 9A-9K, Lewis rat lung grafts were extracted after cardiac death and stored in 4° C. UW solution saturated with Dex (0.1 nM) or without Dex (Vehicle) for 16 hours (lung graft cold ischemia CIO 16 hr). Nrf-2 siRNA or atipamezole was given to the donor before graft extracting. Dual labelling of Rip-3 (red) and TLR-4 (green) in lung tissue after (FIG. 9A) SiRNA treatment or (FIG. 9B) atipamezole. Fluorescent intensity of (FIG. 9C) RIPK3 and (FIG. 9D) TLR-4 in lung tissue. The expression of 3-nitrotyrosine and 4-hydroxynonenal was assessed with immunofluorescent labelling after (FIG. 9E) SiRNA treatment or (FIG. 9F) Atipamezole. Fluorescent intensity of (FIG. 9G) 3-nitrotyrosine and (FIG. 9H) 4-hydroxynonenal. Nuclei were counterstained with 4′,6-diamidino-2-phenylindole (DAPI) (blue). (FIGS. 9I and 9K) Histology (haematoxylin and eosin staining) of the lung graft and injury score. (FIG. 9J) HMGB-1 in lung graft tissue, were assessed by ELISA. Scale bar: 50 μm. Data is expressed as mean±SD (n=6), (*p<0.05, **p<0.01 and ***p<0.001). NC: naïve control, rCI: renal graft cold ischemia. HMGB, high mobility group box 1 protein; CI, cold ischaemia; NC, naïve control; TLR-4, toll-like receptor 4.

### Example 3: Exposure of Dexmedetomidine, Combined with Xenon or Argon, in Ex Vivo Grafts, Reduced Graft Damage Associated with Ischemia-Reperfusion Injury

Briefly, after intravenous heparinization (300 U) in 1 ml saline via the penile vein under 2% isoflurane anaesthesia, cardiac arrest was induced by cervical dislocation (schedule 1 killing). The cessation of the heart beat was observed within 3-5 minutes and donor animals were kept for 40 minutes on a 37° C. pad. The grafts were extracted and then machine-perfused with UW solution at 4° C.[18] with a flow rate of 1.5-2 ml/min (10% cardiac output/kidney in rats) [39] for 4 hours (FIG. 1A) and then kept in the preserving solution containing the same therapeutant until 24 hours prior to transplant surgery.

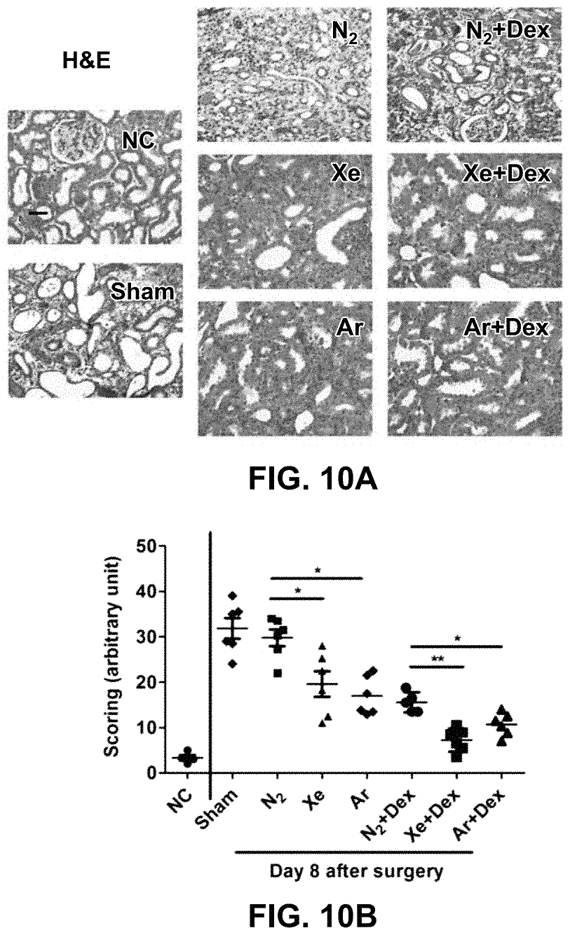

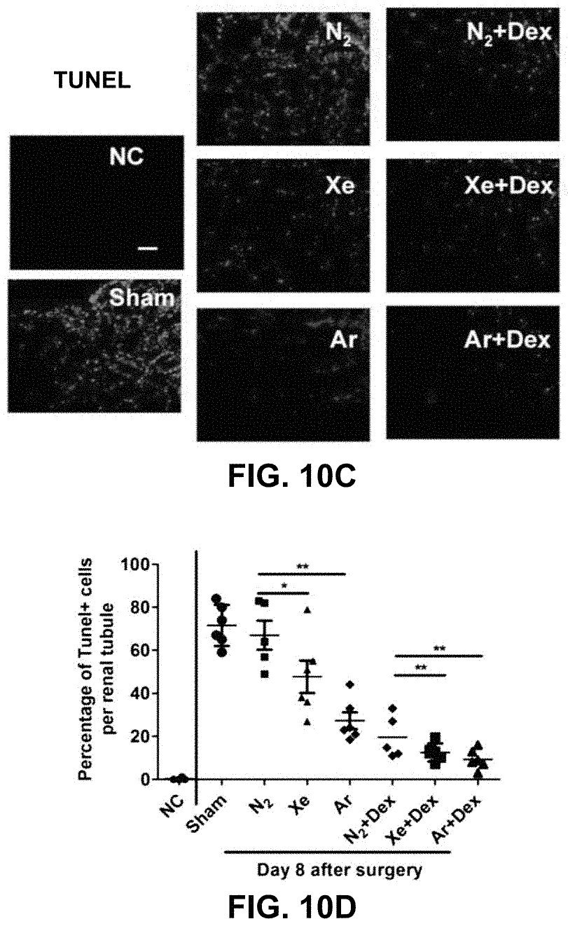

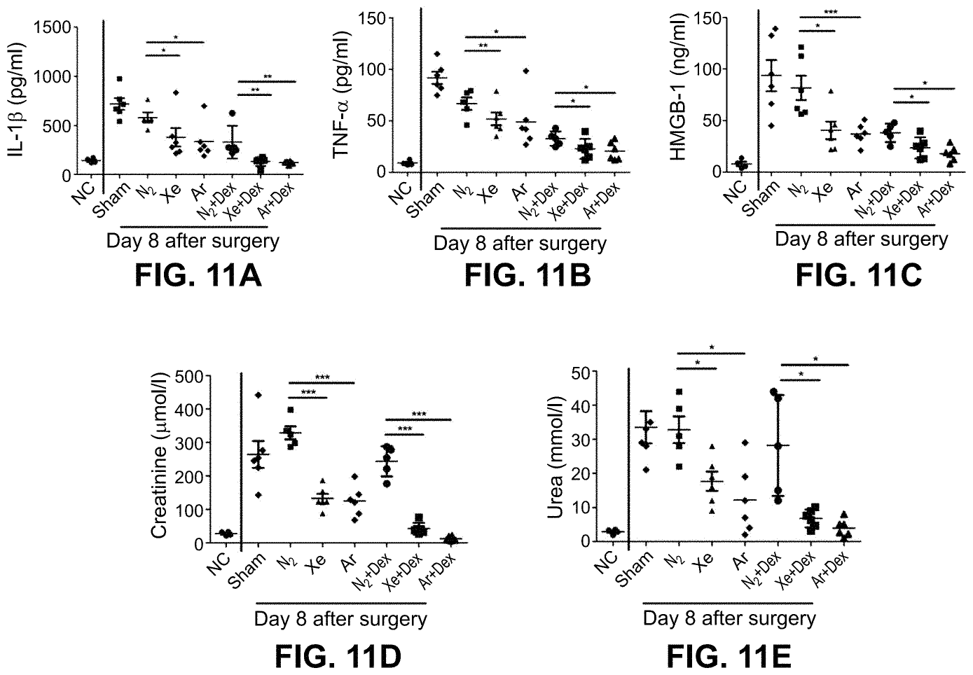

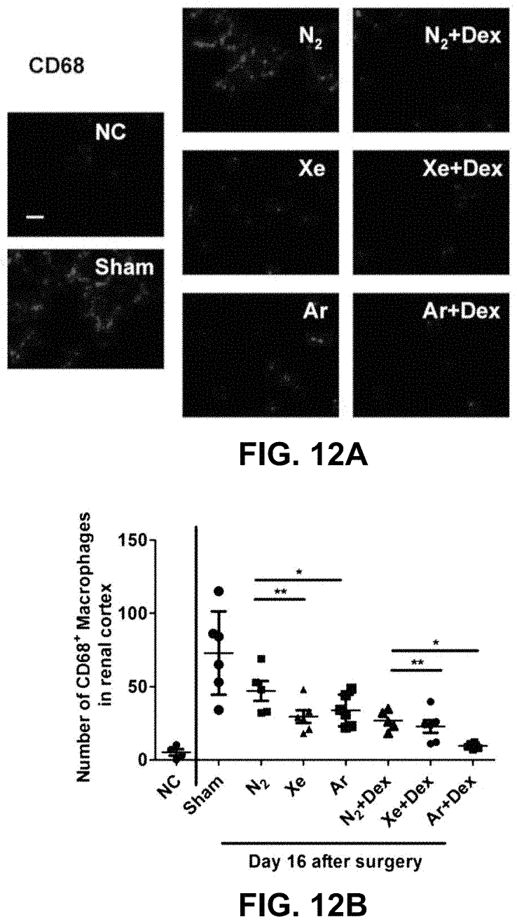

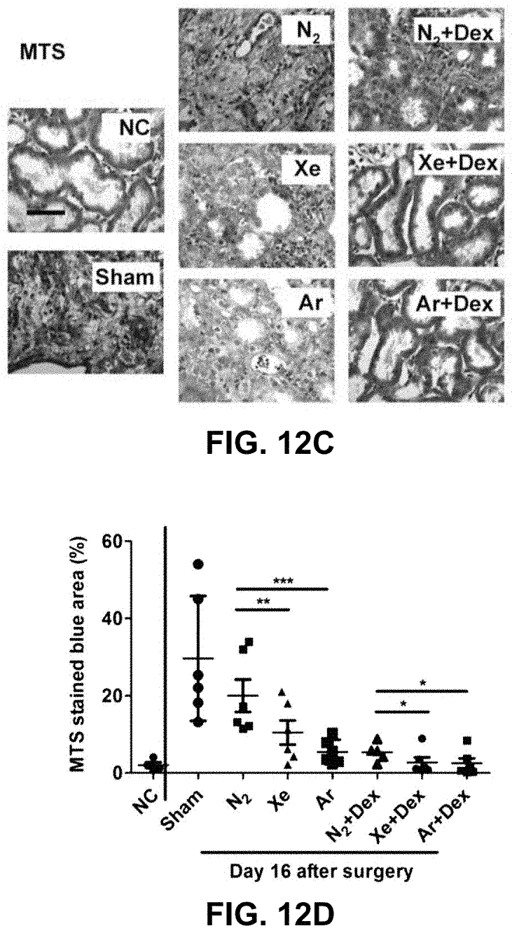

This protocol was obtained from our pilot studies and the both graft injury and a therapeutic window can be achieved. The preserving solution was saturated with 70% nitrogen, xenon or argon gas, combined with or without dexmedetomidine 0.1 nM [32]. The orthotopic renal transplantation into Lewis recipients was conducted under surgical anaesthesia (2% isoflurane) and aseptic conditions and their contralateral kidneys were removed at the end of surgery as we reported previously [22]. The Lewis recipient received cyclosporine A (5 mg/kg/day intramuscular injection per day) for 10 days to prevent acute immune rejection [21, 23]. Our preliminary data showed ex vivo exposure to xenon or argon preserved the renal architrave during prolonged cold preservation and addition of dexmedetomidine conferred even better protection (FIGS. 10A-10D) on day 8 after transplantation, suppressed the inflammatory response (FIGS. 11A-11C) and induced a quick functional recovery (FIGS. 11D and 11E). Macrophage infiltration and renal fibrosis were attenuated by the treatments on day 16 after surgery (FIGS. 12A-12D).

With respect to FIGS. 10A-10D, Fischer rats renal grafts from cardiac arrest donation were stored with UW preserving solution at 4° C., saturated with nitrogen or xenon or argon gas (70% N₂ or Xe or Ar and 5% CO₂ balanced with O₂ supplemented with Dex), machine perfused for 4 hours and stored until 24 hours. Normal kidney graft serves as naive control (NC), grafts treated with preserving solution only served as sham, and the grafts were then transplanted into Lewis recipient and finally harvested day 8 after transplantation. (FIG. 10A) Renal morphology were assessed by H and E staining (n=4-6) and (FIG. 10B) evaluated by the injury scoring system. (FIG. 10C) TUNEL staining of renal tubules in renal cortex. (FIG. 10D) Percentage of TUNEL+ tubular cells in renal cortex. Data are means±SD. *p<0.05 and **p<0.01. Scale bar: 50 μm. Xe: xenon, Ar: Argon. Dex: Dexmedetomidine.

With respect to FIGS. 11A-11E, Fischer rats renal grafts from cardiac arrest donation were stored with UW preserving solution at 4° C., saturated with nitrogen or xenon or argon gas (70% N₂ or Xe or Ar and 5% CO₂ balanced with O₂ supplemented with Dex), machine perfused for 4 hours and stored until 24 hours. Normal kidney graft serves as naive control (NC), grafts treated with preserving solution only served as sham, and the grafts were then transplanted into Lewis recipient and finally harvested day 8 after transplantation. (FIGS. 11A-C) Serum IL-1β, TNF-α, and HMGB-1 concentration was assessed by ELISA (FIGS. 11D and 11E) Serum creatinine and urea concentration were analysed. Data is expressed as mean±SD (n=4-6), *p<0.05 and **p<0.01 and ***p<0.001). Xe: xenon, Ar: Argon. Dex: Dexmedetomidine.

With respect to FIGS. 12A-12D, Fischer rats renal grafts from cardiac arrest donation were stored with UW preserving solution at 4° C., saturated with nitrogen or xenon or argon gas (70% N₂ or Xe or Ar and 5% CO₂ balanced with O₂ supplemented with Dex), Machine perfused for 4 hours and stored until 24 hours. Normal kidney graft serves as naive control (NC), grafts treated with preserving solution only served as sham, and the grafts were then transplanted into Lewis recipient and finally harvested day 16 after transplantation. (FIG. 12A) Infiltrated CD68+ macrophages and (FIG. 12B) number of CD68+ cells per ×20 image and (FIG. 12C) Renal fibrosis (blue MTS staining) and (FIG. 12D) Renal fibrosis, percentage of blue MTS staining. Data is expressed as Mean±SD (n=4-6), *p<0.05, **p<0.01, ***p<0.001. Xe: xenon, Ar: Argon. Dex: Dexmedetomidine.

Taken together, our novel preliminary results indicate that xenon or argon combined with dexmedetomidine conferred significant protection in ex vivo renal allograft from cardiac arrest donation.

### REFERENCES

1. Laubach, V. E. and A. K. Sharma, Mechanisms of lung ischemia-reperfusion injury. Curr Opin Organ Transplant, 2016. 21(3): p. 246-52.
2. Thabut, G. and H. Mal, Outcomes after lung transplantation. J Thorac Dis, 2017. 9(8): p. 2684-2691.
3. Introduction. Am J Transplant, 2016. 16 Suppl 2: p. 8-10.
4. Ferrari, R. S. and C. F. Andrade, Oxidative Stress and Lung Ischemia-Reperfusion Injury. Oxid Med Cell Longev, 2015. 2015: p. 590987.
5. Buchanan, P. M., et al., Association of lower costs of pulsatile machine perfusion in renal transplantation from expanded criteria donors. Am J Transplant, 2008. 8(11): p. 2391-401.
6. van der Hoeven, J. A., et al., Relationship between duration of brain death and hemodynamic (in)stability on progressive dysfunction and increased immunologic activation of donor kidneys. Kidney Int, 2003. 64(5): p. 1874-82.
7. de Vries, D. K., et al., Donor brain death predisposes human kidney grafts to a proinflammatory reaction after transplantation. Am J Transplant, 2011. 11(5): p. 1064-70.
8. van Der Hoeven, J. A., et al., Effects of brain death and hemodynamic status on function and immunologic activation of the potential donor liver in the rat. Ann Surg, 2000. 232(6): p. 804-13.
9. Herijgers, P., et al., Changes in organ perfusion after brain death in the rat and its relation to circulating catecholamines. Transplantation, 1996. 62(3): p. 330-5.
10. Nicholson, M. L., et al., A comparison of the results of renal transplantation from non-heart-beating, conventional cadaveric, and living donors. Kidney Int, 2000. 58(6): p. 2585-91.
11. Pascual, J., J. Zamora, and J. D. Pirsch, A systematic review of kidney transplantation from expanded criteria donors. Am J Kidney Dis, 2008. 52(3): p. 553-86.
12. Carden, D. L. and D. N. Granger, Pathophysiology of ischemia-reperfusion injury. J Pathol, 2000. 190(3): p. 255-66.
13. Schrier, R. W., et al., Acute renal failure: definitions, diagnosis, pathogenesis, and therapy. J Clin Invest, 2004. 114(1): p. 5-14.
14. Wu, H., et al., TLR4 activation mediates kidney ischemia/reperfusion injury. J Clin Invest, 2007. 117(10): p. 2847-59.
15. Sanni, A. O., et al., Non-heart-beating kidney transplantation: 6-year outcomes. Transplant Proc, 2006. 38(10): p. 3396-7.
16. Maathuis, M. H., H. G. Leuvenink, and R. J. Ploeg, Perspectives in organ preservation. Transplantation, 2007. 83(10): p. 1289-98.
17. Fuller, B. J. and C. Y. Lee, Hypothermic perfusion preservation: the future of organ preservation revisited? Cryobiology, 2007. 54(2): p. 129-45.
18. Moers, C., et al., Machine perfusion or cold storage in deceased-donor kidney transplantation. N Engl J Med, 2009. 360(1): p. 7-19.
19. Endre, Z. H., Renal ischemic preconditioning: finally some good news for prevention of acute kidney injury. Kidney Int, 2011. 80(8): p. 796-8.
20. Ma, D., et al., Xenon preconditioning protects against renal ischemic-reperfusion injury via HIF-1 alpha activation. J Am Soc Nephrol, 2009. 20(4): p. 713-20.
21. Zhao, H., et al., Xenon Treatment Protects Against Cold Ischemia Associated Delayed Graft Function and Prolongs Graft Survival in Rats. Am J Transplant, 2013.
22. Zhao, H., et al., Xenon treatment attenuates early renal allograft injury associated with prolonged hypothermic storage in rats. FASEB J, 2013. 27(10): p. 4076-88.
23. Zhao, H., et al., Early treatment with xenon protects against the cold ischemia associated with chronic allograft nephropathy in rats. Kidney Int, 2013.
24. Zhao, H., et al., A novel strategy for preserving renal grafts in an ex vivo setting: potential for enhancing the marginal donor pool. FASEB J, 2013.
25. Loetscher, P. D., et al., Argon: neuroprotection in in vitro models of cerebral ischemia and traumatic brain injury. Crit Care, 2009. 13(6): p. R206.
26. Ryang, Y. M., et al., Neuroprotective effects of argon in an in vivo model of transient middle cerebral artery occlusion in rats. Crit Care Med, 2011. 39(6): p. 1448-53.
27. Zhuang, L., et al., The protective profile of argon, helium, and xenon in a model of neonatal asphyxia in rats. Crit Care Med, 2012. 40(6): p. 1724-30.
28. Irani, Y., et al., Noble gas (argon and xenon)-saturated cold storage solutions reduce ischemia-reperfusion injury in a rat model of renal transplantation. Nephron Extra, 2011. 1(1): p. 272-82.
29. Hall, J. E., et al., Sedative, amnestic, and analgesic properties of small-dose dexmedetomidine infusions. Anesth Analg, 2000. 90(3): p. 699-705.
30. Ma, D., et al., Dexmedetomidine produces its neuroprotective effect via the alpha 2A-adrenoceptor subtype. Eur J Pharmacol, 2004. 502(1-2): p. 87-97.
31. Si, Y., et al., Dexmedetomidine protects against renal ischemia and reperfusion injury by inhibiting the JAK/STAT signaling activation. J Transl Med, 2013. 11(1): p. 141.
32. Gu, J., et al., Dexmedetomidine provides renoprotection against ischemia-reperfusion injury in mice. Crit Care, 2011. 15(3): p. R153.
33. Gallego-Ligorit, L., et al., Use of Dexmedetomidine in Cardiothoracic and Vascular Anesthesia. J Cardiothorac Vasc Anesth, 2017.
34. van den Eijnden, M. M., et al., Effect of brain death and non-heart-beating kidney donation on renal function and injury: an assessment in the isolated perfused rat kidney. Exp Clin Transplant, 2003. 1(2): p. 85-95.
35. Chen, Q., et al., alpha2-adrenoreceptor modulated FAK pathway induced by dexmedetomidine attenuates pulmonary microvascular hyper-permeability following kidney injury. Oncotarget, 2016. 7(35): p. 55990-56001.
36. Koksel, O., et al., Inhibition of poly(ADP-ribose) polymerase attenuates lung tissue damage after hind limb ischemia-reperfusion in rats. Pharmacol Res, 2005. 51(5): p. 453-62.
37. Hamar, P., et al., Small interfering RNA targeting Fas protects mice against renal ischemia-reperfusion injury. Proc Natl Acad Sci USA, 2004. 101(41): p. 14883-8.
38. Ozaki, K. S., et al., Carbon monoxide inhibits apoptosis during cold storage and protects kidney grafts donated after cardiac death. Transpl Int, 2012. 25(1): p. 107-17.
39. Slama, M., et al., Echocardiographic measurement of cardiac output in rats. Am J Physiol Heart Circ Physiol, 2003. 284(2): p. H691-7

1. A method of inducing factors in an organ or composite tissue graft that promote cell survival after ischemia-reperfusion comprising: treating an organ or composite tissue graft from a mammalian donor with Dexmedetomidine in combination with a noble gas selected from the group consisting of: xenon and argon at a sufficient concentration and duration to stimulate production of said cell survival factor.

2. The method of claim 1, wherein the organ is selected from the group consisting of: heart, lung, kidney, liver, intestine, pancreas, vasculature, cornea, and skin.

3. The method of claim 1, wherein the organ or composite tissue graft is transplanted to a mammalian recipient that is a different individual from the organ donor after being treated with the Dexmedetomidine and noble gas combination.

4. The method of claim 3, wherein the organ or composite tissue graft is further treated with the Dexmedetomidine and noble gas combination after being transplanted to the mammalian recipient.

5. The method of claim 1, wherein the organ or composite tissue graft is a marginal donor organ selected from the group consisting of: organ or composite tissue graft donated after cardiac death of donor (DCD) and organ or composite tissue graft donated after brain death of donor (DBD).

6. The method of claim 1, wherein treating the organ or composite tissue graft with Dexmedetomidine and noble gas combination is performed in an organ preserving solution selected from the group consisting of: UW solution, Soltran solution, and Collins Solution.

7. The method of claim 1, wherein the mammalian organ or composite tissue graft is treated with Dexmedetomidine in combination with both xenon and argon.

8. The method of claim 7, wherein the mammalian organ or composite tissue graft is treated with a combination of Dexmedetomidine, xenon, argon, and oxygen.

9. The method of claim 8, wherein the combination comprises between: 0.05-0.2 nM of Dexmedetomidine, 25-35% oxygen, 30-40% argon, and 25-35% xenon.

10. The method of claim 9, wherein the combination further comprises 2-10% CO2.

11. The method of claim 1, wherein the mammalian organ or composite tissue graft is treated in an ex vivo preservation stage after being removed from a donor and before being transplanted to a recipient.

12. The method of claim 11, wherein the donor is a marginal donor.

13. The method of claim 1, wherein the donor is a marginal donor.

14. A method of inducing factors in an organ or composite tissue graft that promote cell survival after ischemia-reperfusion comprising: treating an organ or composite tissue graft from a mammalian donor with xenon and argon at a sufficient concentration and duration to stimulate production of said cell survival factor.

15. The method of claim 14, wherein the organ or composite tissue graft is transplanted to a mammalian recipient that is a different individual from the organ donor after being contacted with xenon and argon.

16. The method of claim 15, wherein the organ or composite tissue graft is further treated with xenon and argon after being transplanted to the mammalian recipient.

17. The method of claim 15, wherein the xenon and argon are contacted to the organ or composite tissue graft in an ex vivo preservation stage after the organ is removed from the donor and before being transplanted to a recipient.
